(19) United States
(12) Patent Application Publication
(10) Pub. No.: US 2021/0067703 A1
(43) Pub. Date: Mar. 4, 2021

(54) CAMERA PHASE DETECTION AUTO FOCUS (PDAF) ADAPTIVE TO LIGHTING CONDITIONS VIA SEPARATE ANALOG GAIN CONTROL

(71) Applicant: QUALCOMM Incorporated, San Diego, CA (US)

(72) Inventors: Ravi Shankar KADAMBALA, Hyderabad (IN); Soman Ganesh NIKHARA, Hyderabad (IN); Bapineedu Chowdary GUMMADI, Hyderabad (IN)

(21) Appl. No.: 16/552,978

(22) Filed: Aug. 27, 2019

(51) Int. Cl. H04N 5/232

(52) U.S. Cl. CPC H04N 5/232122

(57) ABSTRACT

A camera image sensor captures imaging pixel data and focus pixel data. The camera determines an imaging analog gain based on the imaging pixel data, and determines a focus analog gain based on the focus pixel data. When capturing the one or more subsequent frames, the image sensor applies the imaging analog gain to the imaging pixels and applies the focus analog gain to the focus pixels. Optionally, applying the focus analog gain to the focus pixels brings an average focus pixel luminance within a range, or brings a phase disparity confidence above a threshold.

### FIELD

The present disclosure generally relates to camera autofocus, and more specifically to techniques and systems for providing separate analog gain control for photodiodes used for focus.

### BACKGROUND

A camera is a device that captures images, such as still images or video frames, by receiving light through a lens and by using the lens (and sometimes one or more mirrors) to bend and focus the light onto an image sensor or a photosensitive material such as photographic film. The resulting images are captured by the image sensor and either stored on the photographic film, which can be developed into printed photographs, or stored digitally onto a secure digital (SD) card or other storage device. To capture a clear image, as opposed to a blurry image, a camera must be focused properly. Focusing a camera involves moving the lens forward and backward to ensure that light coming from an object that is the intended subject of the captured image is being properly focused onto the image sensor or photographic film. In some cameras, focus is adjusted manually by the photographer, typically via a dial along the camera that the photographer rotates clockwise or counter-clockwise to move the lens forward or backward.

### SUMMARY

Systems and techniques are described herein for processing one or more images. A camera image sensor captures imaging pixel data and focus pixel data. The camera determines an imaging analog gain based on the imaging pixel data, and determines a focus analog gain based on the focus pixel data. When capturing the one or more subsequent frames, the image sensor applies the imaging analog gain to the imaging pixels and applies the focus analog gain to the focus pixels. Optionally, applying the focus analog gain to the focus pixels brings an average focus pixel luminance within a range, or brings a phase disparity confidence above a threshold. The focus pixel data may then be used for phase detection autofocus (PDAF), and the image pixel data may be used for generating a focused image.

In one example, a method includes receiving first imaging pixel data and first focus pixel data associated with a first frame from an image sensor. The image sensor includes an array of pixels that includes imaging pixels and focus pixels. Imaging pixel data is based on signals from the imaging pixels, and focus pixel data is based on signals from the focus pixels. The method also includes determining a first sensor gain based on the first imaging pixel data and determining a second sensor gain based on the first focus pixel data. The method also includes applying the first sensor gain to the imaging pixels when capturing one or more subsequent frames and applying the second sensor gain to the focus pixels when capturing the one or more subsequent frames.

In some cases, the method further includes storing the first sensor gain in a first register of the image sensor and storing the second sensor gain in a second register of the image sensor. In some cases, the image sensor includes a programmable gain amplifier (PGA). Applying the first sensor gain to the imaging pixels is performed using the PGA, and applying the second sensor gain to the focus pixels is performed using the PGA.

In some cases, the method further includes determining an average focus pixel luminance associated with the first focus pixel data, identifying that the average focus pixel luminance falls outside of a luminance range, and determining the second sensor gain based on the luminance range. In some cases, the second sensor gain may be determined based on the luminance range such that applying the second sensor gain to the first focus pixel data modifies the average focus pixel luminance to fall within the defined luminance range. In some cases, the first sensor gain and the second sensor gain are different.

In some cases, the method further includes determining an average focus pixel luminance associated with the first focus pixel data, identifying that the average focus pixel luminance falls within a luminance range, and determining the second sensor gain based on the first sensor gain. In some cases, the first sensor gain and the second sensor gain are equivalent.

In some cases, the method further includes determining a phase disparity confidence associated with the first focus pixel data, identifying that the phase disparity confidence falls below a confidence threshold, and determining the second sensor gain based on the confidence threshold. In some cases, the second sensor gain is determined based on the confidence threshold such that applying the second sensor gain to the first focus pixel data modifies the phase disparity confidence to exceed the confidence threshold. In some cases, the first sensor gain and the second sensor gain are different.

In some cases, the method further includes determining a phase disparity confidence associated with the first focus pixel data, identifying that the phase disparity confidence exceeds a confidence threshold, and determining the second sensor gain based on the first sensor gain. In some cases, the first sensor gain and the second sensor gain are equivalent.

In another example, a system includes an image sensor that includes an array of pixels, the array of pixels including imaging pixels and focus pixels. The system further includes one or more memory devices storing instructions and one or more processors executing the instructions. Execution of the instructions by the one or more processors causes the one or more processors to perform operations. The operations include receiving first imaging pixel data and first focus pixel data associated with a first frame from an image sensor. Imaging pixel data is based on signals from the imaging pixels, and focus pixel data is based on signals from the focus pixels. The operations also include determining a first sensor gain based on the first imaging pixel data and determining a second sensor gain based on the first focus pixel data. The operations also include sending the first sensor gain to the image sensor, causing the image sensor to apply the first sensor gain to the imaging pixels when capturing one or more subsequent frames. The operations also include sending the second sensor gain to the image sensor, causing the image sensor to apply the second sensor gain to the focus pixels when capturing the one or more subsequent frames.

In some cases, the image sensor includes a first register and a second register. Sending the first sensor gain to the image sensor causes the image sensor to store the first sensor gain in the first register, and sending the second sensor gain to the image sensor causes the image sensor to store the second sensor gain in the second register. In some cases, the image sensor includes a programmable gain amplifier (PGA). The image sensor applies the first sensor gain to the imaging pixels using the PGA. The image sensor applies the second sensor gain to the focus pixels using the PGA.

In some cases, the system operations include determining an average focus pixel luminance associated with the first focus pixel data, identifying that the average focus pixel luminance falls outside of a luminance range, and determining the second sensor gain based on the luminance range. In some cases, the second sensor gain may be determined based on the luminance range such that applying the second sensor gain to the first focus pixel data modifies the average focus pixel luminance to fall within the defined luminance range. In some cases, the first sensor gain and the second sensor gain are different.

In some cases, the system operations include determining an average focus pixel luminance associated with the first focus pixel data, identifying that the average focus pixel luminance falls within a luminance range, and determining the second sensor gain based on the first sensor gain. In some cases, the first sensor gain and the second sensor gain are equivalent.

In some cases, the system operations include determining a phase disparity confidence associated with the first focus pixel data, identifying that the phase disparity confidence falls below a confidence threshold, and determining the second sensor gain based on the confidence threshold. In some cases, the second sensor gain is determined based on the confidence threshold such that applying the second sensor gain to the first focus pixel data modifies the phase disparity confidence to exceed the confidence threshold. In some cases, the first sensor gain and the second sensor gain are different.

In some cases, the system operations include determining a phase disparity confidence associated with the first focus pixel data, identifying that the phase disparity confidence exceeds a confidence threshold, and determining the second sensor gain based on the first sensor gain. In some cases, the first sensor gain and the second sensor gain are equivalent.

In another example, a non-transitory computer readable storage medium has a program embodied thereon. The program is executable by one or more processors to perform a method. The method includes receiving first imaging pixel data and first focus pixel data associated with a first frame from an image sensor. The image sensor includes an array of pixels that includes imaging pixels and focus pixels. Imaging pixel data is based on signals from the imaging pixels, and focus pixel data is based on signals from the focus pixels. The method also includes determining a first sensor gain based on the first imaging pixel data and determining a second sensor gain based on the first focus pixel data. The method also includes applying the first sensor gain to the imaging pixels when capturing one or more subsequent frames and applying the second sensor gain to the focus pixels when capturing the one or more subsequent frames.

In some cases, the program method further includes storing the first sensor gain in a first register of the image sensor and storing the second sensor gain in a second register of the image sensor. In some cases, the image sensor includes a programmable gain amplifier (PGA). Applying the first sensor gain to the imaging pixels is performed using the PGA, and applying the second sensor gain to the focus pixels is performed using the PGA.

In some cases, the program method further includes determining an average focus pixel luminance associated with the first focus pixel data, identifying that the average focus pixel luminance falls outside of a luminance range, and determining the second sensor gain based on the luminance range. In some cases, the second sensor gain may be determined based on the luminance range such that applying the second sensor gain to the first focus pixel data modifies the average focus pixel luminance to fall within the defined luminance range. In some cases, the first sensor gain and the second sensor gain are different.

In some cases, the program method further includes determining an average focus pixel luminance associated with the first focus pixel data, identifying that the average focus pixel luminance falls within a luminance range, and determining the second sensor gain based on the first sensor gain. In some cases, the first sensor gain and the second sensor gain are equivalent.

In some cases, the program method further includes determining a phase disparity confidence associated with the first focus pixel data, identifying that the phase disparity confidence falls below a confidence threshold, and determining the second sensor gain based on the confidence threshold. In some cases, the second sensor gain is determined based on the confidence threshold such that applying the second sensor gain to the first focus pixel data modifies the phase disparity confidence to exceed the confidence threshold. In some cases, the first sensor gain and the second sensor gain are different.

In some cases, the program method further includes determining a phase disparity confidence associated with the first focus pixel data, identifying that the phase disparity confidence exceeds a confidence threshold, and determining the second sensor gain based on the first sensor gain. In some cases, the first sensor gain and the second sensor gain are equivalent.

In another example, a method includes receiving imaging pixel data and focus pixel data from an image sensor. The image sensor includes an array of pixels that includes imaging pixels and focus pixels. The imaging pixel data is based on signals from the imaging pixels, and focus pixel data is based on signals from the focus pixels. The method also includes applying a first sensor gain to the imaging pixels and applying a second sensor gain that is different from the first sensor gain to the focus pixels.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1A illustrates a Phase Detection Auto Focus (PDAF) camera system that is in phase and therefore in focus.

FIG. 1B illustrates the PDAF camera system of FIG. 1A that is out of phase with a front focus.

FIG. 1C illustrates the PDAF camera system of FIG. 1A that is out of phase with a back focus.

FIG. 2A illustrates a top-down view of a pixel array configuration of an image sensor with masks partially covering focus pixel photodiodes.

FIG. 2B is a legend identifying elements of FIG. 2A.

FIG. 2C illustrates a top-down view of a pixel array configuration of an image sensor with two side-by-side focus pixels covered by a 2 pixel by 1 pixel microlens.

FIG. 2D illustrates a top-down view of a pixel array configuration of an image sensor with four neighboring focus pixels covered by a 2 pixel by 2 pixel microlens.

FIG. 2E illustrates a top-down view of a pixel array configuration of an image sensor in which at least one focus pixel has two photodiodes.

FIG. 2F illustrates a top-down view of a pixel array configuration of an image sensor in which at least one focus pixel has four photodiodes.

FIG. 3A illustrates a side view of a single pixel of a pixel array of an image sensor that is partially covered with a mask.

FIG. 3B illustrates a side view of two pixels of a pixel array of an image sensor, the two pixels covered by a 2 pixel by 1 pixel microlens.

FIG. 4 is a block diagram illustrating a camera system that applies different analog gain to imaging pixel data and focus pixel data.

FIG. 5 is a flow diagram illustrating processing of image sensor data to determine and apply two sensor gains.

FIG. 6 is a flow diagram illustrating processing of image sensor data to determine an imaging analog gain voltage for imaging pixel data and a focus analog gain voltage for focus pixel data based on luminance.

FIG. 7 is a flow diagram illustrating performance of phase detection auto focus based on the focus analog gain voltage.

FIG. 8 is a flow diagram illustrating automatic exposure (AE) controls for determining a settled exposure setting and automatic gain control (AGC) for determining an imaging analog gain voltage for imaging pixel data.

FIG. 9 is a flow diagram illustrating processing of image sensor data to determine an imaging analog gain voltage for imaging pixel data and a focus analog gain voltage for focus pixel data based on confidence.

FIG. 10A illustrates frame skipping in the context of a frame capture timeline.

FIG. 10B illustrates exposure adjustment in the context of a frame capture timeline.

FIG. 11 shows an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Some modern cameras include automatic focusing functionality (“autofocus”) that allows the camera to focus automatically prior to capturing the desired image. Various autofocus technologies exist. Active autofocus (“active AF”) relies on determining a range between the camera and a subject of the image via a range sensor of the camera, typically by emitting infrared lasers or ultrasound signals and receiving reflections of those signals. While active AF works well in many cases and can be fairly quick, cameras with active AF can be bulky and expensive. Active AF can fail to properly focus on subjects that are very close to the camera lens (macro photography), as the range sensor is not perfectly aligned with the camera lens, and this difference is exacerbated the closer the subject is to the camera lens. Active AF can also fail to properly focus on faraway subjects, as laser or ultrasound transmitters used in the range sensors that are used for active AF are typically not very strong. Active AF also often fails to properly focus on subjects on the other side of a window than the camera, as the range sensor typically determines the range to the window rather than to the subject.

Passive autofocus (“passive AF”) uses the camera's own image sensor to focus the camera, and thus does not require additional sensors to be integrated into the camera. Passive AF techniques include Contrast Detection Auto Focus (CDAF), Phase Detection Auto Focus (PDAF), and in some cases hybrid systems that use both.

In CDAF, the lens of a camera moves through a range of lens positions, typically with pre-specified distance intervals between each tested lens position, and attempts to find a lens position at which contrast between the subject's pixels and background pixels are maximized. CDAF relies on trial and error and has high latency as a result. The CDAF process also requires the motor that moves the lens to be actuated and stopped repeatedly in a short span of time every time the camera needs to focus for a photo, which puts stress on components and expends a fair amount of battery power. The camera can still fail to find a satisfactory focus using CDAF, for example if the distance interval between tested lens positions is too large, as the ideal focus may actually be between tested lens positions. CDAF may also struggle in images of subjects without high-contrast features, such as walls, or in images taken in low-light or high-light conditions where lighting conditions fade or blend features that would have higher contrast in different lighting conditions.

In PDAF, photodiodes within the camera are used to check whether light that is received by the lens of a camera from different angles converge to create a focused image that is “in phase” or fails to converge and thus creates a blurry images that is “out of phase.” If light received from different angles is out of phase, the camera identifies a direction in which the light is out of phase to determine whether the lens needs to be moved forward or backward, and identifies a phase disparity indicating how out of phase the light is to determine how far the lens must be moved. In some cases, the lens is moved to the position corresponding to optimal focus. Compared to CDAF, PDAF generally focuses the camera more quickly by not relying on trial and error. PDAF also typically uses less power and wears components less than CDAF by actuating the motor for a single lens motion rather than for many small and repetitive motions. Like CDAF, however, PDAF may also struggle to properly focus in low-light conditions and high-light conditions. Some PDAF solutions also use masks or shielding as discussed further below, which reduces the total amount of light that is received by certain photodiodes. In some cases, a hybrid autofocus solution may be employed that uses PDAF to move the lens to a first position, then uses CDAF to check contrast at a number of lens positions within a defined distance/range of the first position in order to help compensate for any slight errors or inaccuracies in the PDAF autofocus.

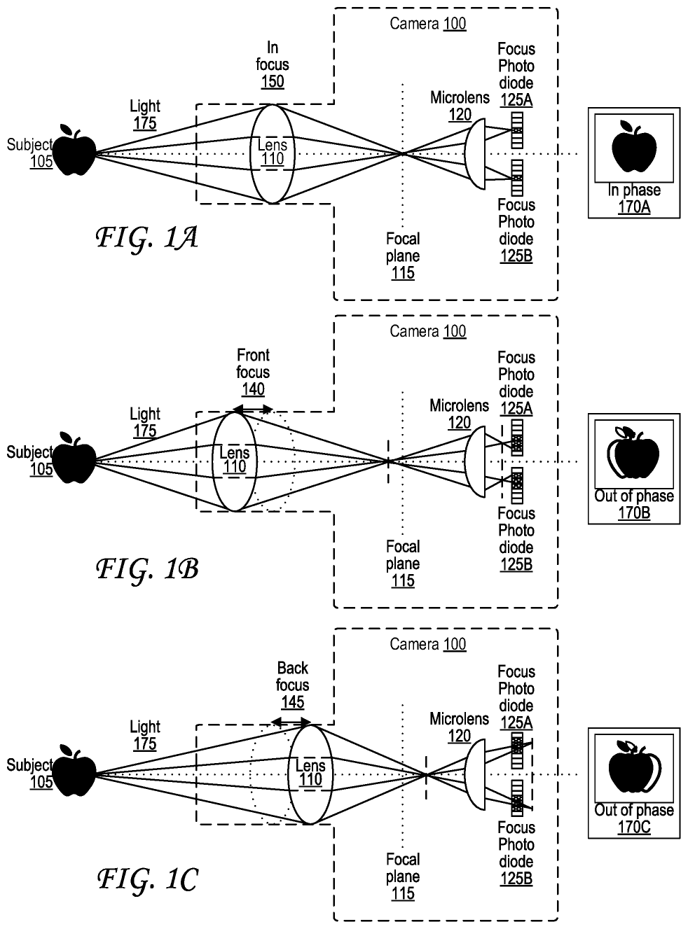

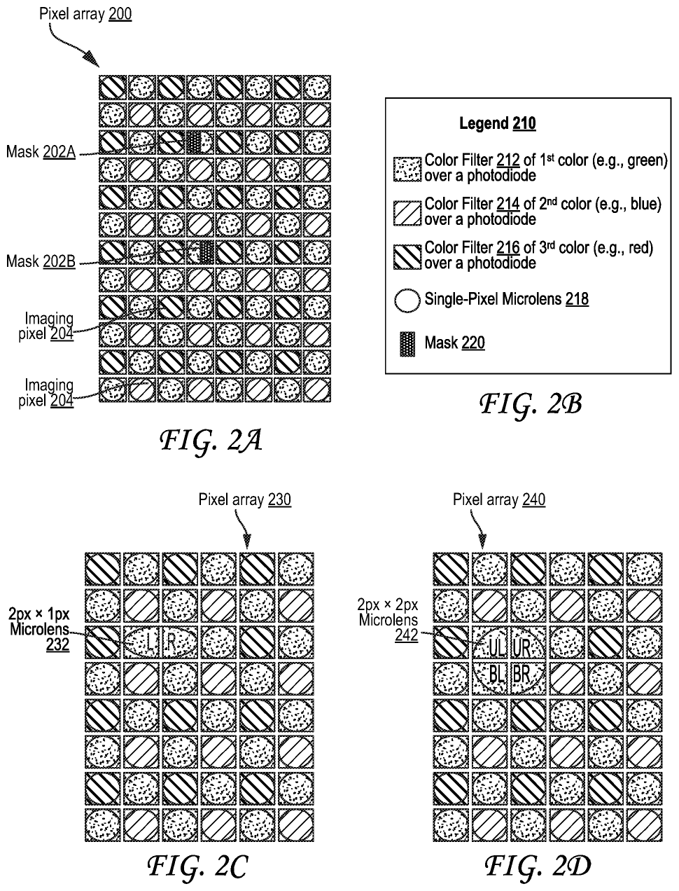

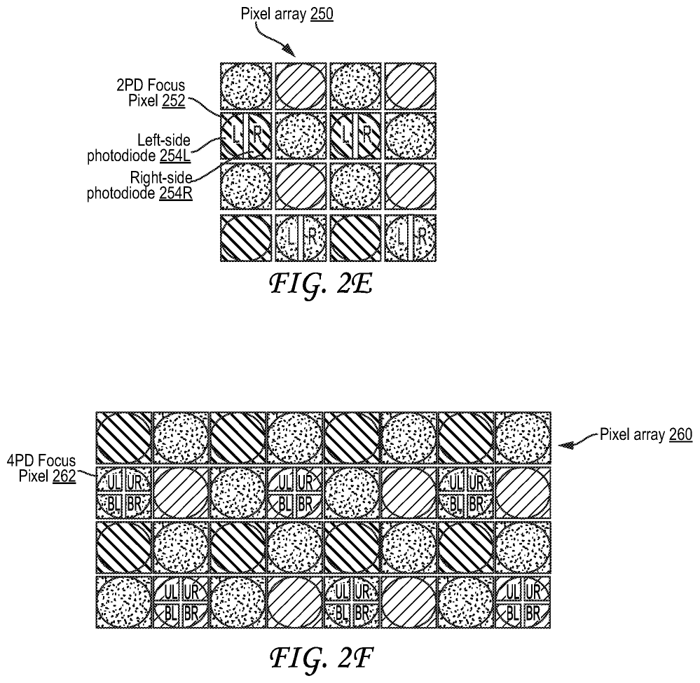

There is a need to improve PDAF performance in low-light and high-light conditions, and in some cases to compensate for low light intake caused in part by blockage of light by masks or shielding used in certain PDAF solutions. As described in more detail below, an image sensor of a camera may include an array of pixels that includes imaging pixels and focus pixels. Examples of PDAF camera systems 100 are illustrated in, and described with respect to, FIG. 1A, FIG. 1B, and FIG. 1C. Examples of pixel arrays in such camera systems 100 are illustrated in, and described with respect to, FIG. 2A, FIG. 2C, and FIG. 2D.

FIG. 1A illustrates a Phase Detection Auto Focus (PDAF) camera system that is in phase and therefore in focus. Rays of light 175 may travel from a subject 105 (e.g., an apple) through a lens 110 that focuses a scene with the subject 105 onto an image sensor (not pictured in its entirety), where the image sensor includes the focus photodiode 125A and the focus photodiode 125B, which correspond to focus pixels. The focus photodiodes 125A and 125B may be associated with one or two focus pixels (e.g., focus photodiode 125A and focus photodiode 125B may be two photodiodes of a single focus pixel sharing a single microlens 120 or focus photodiode 125A may be associated with a first focus pixel and focus photodiode 125B may be associated with a second focus pixel, both focus pixels sharing a single microlens 120) of the pixel array of the image sensor. In some cases, the light rays 175 may travel through a microlens 120 before falling on the focus photodiode 125A and the focus photodiode 125B. When the camera system 100 is in the “in focus” state 150 of FIG. 1A, the rays of light 175 may ultimately converge at a plane that corresponds to the position of the focus photodiode 125A and the focus photodiode 125B. When the camera system 100 is in the “in focus” state 150 of FIG. 1A, rays of light 175 may also converge at a focal plane 115 (also known as an image plane) after passing through the lens 175 but before reaching the microlens 120 and/or focus photodiodes 125A and 125B.

Because the camera 100 of FIG. 1A is in an in-focus state 150, data from focus photodiodes 125A and 125B is aligned, here represented by an image 170A showing a clear and sharp representation of the subject 105 due to this alignment, as opposed to the misaligned representations of the subject 105 caused by the out-of-phase states 140 and 145 in FIG. 1B and FIG. 1C respectively. The in-focus state 150 may also be referred to as an “in-phase” state, as the data from focus photodiode 125A and the focus photodiode 125B have no phase disparity, or have very little phase disparity (e.g., phase disparity falling below a predetermined phase disparity threshold).

FIG. 1B illustrates the PDAF camera system of FIG. 1A that is out of phase with a front focus. The PDAF camera system 100 of FIG. 1B is the same as the PDAF camera system 100 of FIG. 1A, but the lens 110 is moved closer to the subject 105 and further from the focus photodiodes 125A and 125B, and is therefore in a “front focus” state 140. The lens position for the “in focus” state 150 is still drawn in FIG. 1B as a dotted outline for reference, with a double-sided arrow indicating movement of the lens between the “front focus” 140 lens position and the “in focus” 150 lens position.

When the camera system 100 is in the “front focus” state 140 of FIG. 1B, the rays of light 175 may ultimately converge at a plane (denoted by a dashed line) before the position of the focus photodiode 125A and the focus photodiode 125B, that is, between the microlens 120 and the focus photodiodes 125A and 125B. The rays of light 175 may also converge at a position (denoted by another dashed line) before the focal plane 115 after passing through the lens 175 but before reaching the microlens 120 and/or focus photodiodes 125A and 125B. Because the light 175 in the camera 100 of FIG. 1B is out of phase in the “front focus” state 140, data from focus photodiodes 125A and 125B is misaligned, here represented by an image 170B showing misaligned black-colored and white-colored representations of the subject 105, where the direction of misalignment in the image 170B is related to the front focus state 140, and the distance of misalignment in the image 170B is related to the distance of the lens 110 from its position in the focused state 150.

FIG. 1C illustrates the PDAF camera system of FIG. 1A that is out of phase with a back focus. The PDAF camera system 100 of FIG. 1C is the same as the PDAF camera system 100 of FIG. 1A, but the lens 110 is moved further from the subject 105 and closer to the focus photodiodes 125A and 125B, and is therefore in a “back focus” state 145 (also known as a “rear focus” state). The lens position for the “in focus” state 150 is still drawn as a dotted outline for reference, with a double-sided arrow indicating movement of the lens between the “back focus” lens position 145 and the “in focus” lens position 150.

When the camera system 100 is in the “back focus” state 145 of FIG. 1C, the rays of light 175 may ultimately converge at a plane (denoted by a dashed line) beyond the position of the focus photodiode 125A and the focus photodiode 125B. The rays of light 175 may also converge at a position (denoted by another dashed line) beyond the focal plane 115 after passing through the lens 175 but before reaching the microlens 120 and/or focus photodiodes 125A and 125B. Because the light 175 in the camera 100 of FIG. 1C is out of phase in the “back focus” state 145, data from focus photodiodes 125A and 125B is misaligned, here represented by an image 170C showing misaligned black-colored and white colored representations of the subject 105, where the direction of misalignment in the image 170C is related to the back focus state 145, and the distance of misalignment in the image 170C is related to the distance of the lens 110 from its position in the focused state 150.

When the rays of light 175 converge before the plane of the focus photodiodes 125A and 125B as in the front focus state 140 or beyond the plane of the focus photodiodes 125A and 125B as in the back focus state 145, the resulting image produced by the image sensor may be out-of-focus or blurred. In the case that the image is out-of-focus, the lens 110 can be moved forward (toward the subject 105 and away from the photodiodes 125A and 125B) if the lens 110 is in the back focus state 145, or can be moved backward (away from the subject 105 and toward the photodiodes 125A and 125B) if the lens is in the front focus state 140. The lens 110 may be moved forward or backward within a range of positions which in some cases has a predetermined length R representing a possible range of motion of the lens in the camera system 100. The camera system 100, or a computing system therein, may determine a distance and direction of adjusting the position of the lens 100 to bring the image into focus based on one or more phase disparity values calculated as differences between data from two focus photodiodes that receive light from different directions, such as focus photodiodes 125A and 125B. The direction of movement of the lens 110 may correspond to a direction in which the data from the focus photodiodes 125A and 125B is determined to be out of phase, or whether the phase disparity is positive or negative. The distance of movement of the lens 110 may correspond to a degree or amount to which the data from the focus photodiodes 125A and 125B is determined to be out of phase, or the absolute value of the phase disparity.

The camera 100 may include motors (not pictured) that move the lens 110 between lens positions corresponding to the different states (e.g., front focus 140, back focus 145, and in focus 150) and motor actuators (not pictured) that the computing system within the camera activates to actuate the motors. The camera 100 of FIG. 1A, FIG. 1B, and FIG. 1C may in some cases also include various additional non-illustrated components, such as lenses, mirrors, partially reflective (PR) mirrors, prisms, photodiodes, image sensors, and/or other components sometimes found in cameras or other optical equipment. In some cases, the focus photodiodes 125A and 125B may be referred to as PDAF photodiodes, PDAF diodes, phase detection (PD) photodiodes, PD diodes, PDAF pixel photodiodes, PDAF pixel diodes, PD pixel photodiodes, PD pixel diodes, focus pixel photodiodes, focus pixel diodes, pixel photodiodes, pixel diodes, or in some cases simply photodiodes or diodes.

FIG. 2A illustrates a top-down view of a pixel array configuration of an image sensor with masks partially covering focus pixel photodiodes. An image sensor of a camera system may include an array of pixels, such as the pixel array 200 of FIG. 2A. The pixel array 200 may include an array of photodiodes, which is not shown in FIG. 2A as is the photodiodes are covered by color filters (e.g., Bayer filters or other types of color filters as discussed below) and microlenses 218 as identified in the legend 210 of FIG. 2B. Photodiodes of focus pixels are also partially covered by masks 220 in the pixel array 200 of FIG. 2A.

FIG. 2B is a legend identifying elements of FIG. 2A. The legend 210 identifies that a circle represents a microlens 218 of a single pixel, and that a dark shaded rectangle represents a mask 220. The legend 210 of FIG. 2B also identifies that squares with three different patterns each represent color filters 212, 214, and 216, each color filter being for one of three different colors: red, green, or blue. That is, squares of the first pattern represent a color filter 212 for a first color, which may for example be green; squares of the second pattern represent a color filter 214 for a second color, which may for example be blue; and squares of the third pattern represent a color filter 216 for a third color, which may for example be red. These color filters are arranged in color filter arrays (CFAs) over an array of photodiodes in the pixel arrays 200, 230, and 240 of FIG. 2A, FIG. 2C, and FIG. 2D respectively. The colors (and number of colors) identified in the legend 210 of FIG. 2B, and the arrangements of color filters illustrated in the pixel arrays 200, 230, and 240 of FIG. 2A, FIG. 2C, and FIG. 2D, should be understood to be exemplary and should not be construed as limiting. Red, green, and blue color filters are traditionally used in image sensors and are often referred to as Bayer filters. Bayer filter CFAs often include more green Bayer filters than red or blue Bayer filters, for example in a proportion of 50% green, 25% red, 25% blue, to mimic sensitivity to green light in human eye physiology. Bayer filter CFAs with these proportions are sometimes referred to as BGGR, RGBG, GRGB, or RGGB, and are reflected in the presence of the color filter 212 in higher proportion than the color filters 214 and 216 in the pixel arrays 200, 230, and 240 of FIG. 2A, FIG. 2C, and FIG. 2D. Sometimes, in such Bayer filter CFAs, green is treated as two colors, labeled “Gr” and “Gb” respectively. Some CFAs use alternate color schemes and can even include more or fewer colors. For example, some CFAs use cyan, yellow, and magenta color filters instead of the traditional red, green, and blue Bayer color filter scheme. In an arrangement referred to as cyan yellow yellow magenta (CYYM), 50% of the color filters are yellow, while 25% are cyan and 25% are magenta. Some filters also add a fourth green filter to the three cyan, yellow, and magenta filters, together referred to as a cyan yellow green magenta (CYGM) filter. Some CFAs use red, green, blue and “emerald” or cyan, referred to as an RGBE color scheme. In some cases, some mix or combination of the Bayer, CYYM, CYGM, or RGBE color schemes may be used. In some cases, color filters of one or more of the colors of the Bayer, CYYM, CYGM, or RGBE color schemes may be omitted, in some cases leaving only two colors or even one color. While the legend 210 of FIG. 2B lists precisely three color filters 212, 214, and 216, and provides green, red, and blue as examples to adhere to the traditional Bayer filter color scheme, it should be understood that more than three colors or less than three colors may alternately be used in the CFA, and that the colors may vary, for example including red, green, blue, cyan, magenta, yellow, emerald, white (transparent), or some combination thereof. Some image sensors, such as the Foveon X3® sensor, may lack color filters altogether, instead opting to use different photodiodes throughout the pixel array (optionally vertically stacked), the different photodiodes having different spectral sensitivity curves and therefore responding to different wavelengths of light. Monochrome image sensors may also lack color filters and therefore lack color depth. Use of color filters in an image sensor used with the camera systems described further herein should therefore be considered optional.

The pixel array 200 of FIG. 2A is illustrated with two pixels that are used for phase detection auto focus (PDAF), which are referred to herein as focus pixels, but may alternately be referred to as PDAF pixels or phase detection (PD) pixels. Other pixels not used for PDAF may simply be referred to as imaging pixels 204. In the pixel array 200 of FIG. 2A, any pixel without a mask 220 is an imaging pixel 204, even though only two imaging pixels 204 are specifically labeled. While two focus pixels are illustrated in the pixel array 200 of FIG. 2A, both in the same column but with three rows of imaging pixels in between, a different pixel array (not pictured) may have any number of focus pixels (i.e., one or more focus pixels), which may be arranged in any possible pattern or arrangement. In some cases, patterns of focus pixels may repeat across a pixel array, for example in “tiles” that are 8 pixels by 8 pixels in size, or 16 pixels by 16 pixels in size.

The two focus pixels illustrated in FIG. 2A are both partially covered by masks 220, the two masks 220 labeled as mask 202A and mask 202B, respectively. Each of the masks 220 may be a mask or shield made of an opaque and/or reflective material, such as a metal. Each mask 220 limits the amount and direction of light that strikes the photodiode of the focus pixel that is partially covered by the mask. The mask 202A and mask 202B each limit how much light reaches and strikes the underlying focus pixel photodiode from a particular direction, and are disposed over two different focus pixel diodes in an opposite direction to produce a pair of left and right images. For example, the mask 202A is disposed over a left side of a first focus pixel, leaving the right side of that first focus pixel to receive light entering from the right side (the right image). The mask 202B is disposed over a right side of a second focus pixel, leaving the left side of that second focus pixel to receive light entering from the left side (the left image). Because the two focus pixels are both illustrated as half-covered by the masks 220, their focus photodiodes effectively receive 50% of the light that an imaging photodiode (which would not be covered by a mask) in the same location on the pixel array would receive.

Any number of focus pixels may be included in a pixel array of an image sensor. Left and right pairs of focus pixels may be adjacent to one another, or may be spaced apart by one or more imaging pixels 204. The two pixels from a left and right pair of focus pixels may both be in the same row and/or same column of the pixel array, may be in a different row and/or different column, or some combination thereof. While masks 202A and 202B are shown within pixel array 200 as masking left and right portions of the focus pixel photodiodes, this is for exemplary purposes only. Focus pixel masks 220 may instead mask top or bottom portions of the focus pixel photodiodes, thus generating top and bottom images (or “up” and “down” images) from the focus pixel data received by the focus pixels. Like the left and right pairs of focus pixels, top and down pairs of focus pixels may both be in the same row and/or same column of the pixel array, may be in a different row and/or different column, or some combination thereof. A pixel array of an image sensor may have a focus pixel with a mask 220 over a left side of one focus pixel, a mask 220 over a right side of a second focus pixel, a mask 220 over a top side of a third focus pixel, a mask 220 over a bottom side of a fourth focus pixel, and optionally more focus pixels with any of these types of masks 220. Using focus pixels with masks 220 along multiple axes (e.g., left-right pairs of focus pixels as well as top-down pairs of focus pixels) can improve autofocus quality. One reason why autofocus quality can be improved by using focus pixels with masks 220 along multiple axes is because use of masks 220 along left and right sides of focus pixel photodiodes alone for PDAF can lead to poor focus on scenes or subjects with many horizontal edges (i.e., lines that appear along a left-right axis relative to the orientation of the focus pixels and masks 220), and use of masks 220 along top and bottom sides of focus pixel photodiodes alone for PDAF can lead to poor focus on scenes or subjects with many vertical edges (i.e., lines that appear along an up-down axis relative to the orientation of the focus pixels and masks 220).

Some PDAF camera systems do not use masks 220 on focus pixels as in FIG. 2A, but instead cover multiple pixels under a single microlens, which may alternately be referred to as an on-chip lens (OCL). FIG. 2C illustrates a top-down view of a pixel array configuration with two side-by-side focus pixels covered by a 2 pixel by 1 pixel microlens. FIG. 2D illustrates a top-down view of a pixel array configuration with four neighboring focus pixels covered by a 2 pixel by 2 pixel microlens. The pixel arrays 230 and 240 of FIG. 2C and FIG. 2D can also be interpreted based on the legend 210 of FIG. 2B.

Referring to FIGS. 2C and 2D, the 2 pixel by 1 pixel microlens 232 of FIG. 2C and the 2 pixel by 2 pixel microlens 242 of FIG. 2D both span multiple adjacent focus pixels (i.e., the microlenses cover multiple adjacent focus pixel photodiodes), and both can limit the amount and/or direction of light that strikes the focus pixel photodiodes of those focus pixels. The microlens 232 of FIG. 2C covers two horizontally-adjacent focus pixels of a pixel array 230, such that focus pixel data from both focus photodiodes may be generated, with focus pixel data from the left one of the focus pixels (labeled with an “L”) representing light approaching from the left side of the pixel array 230, and focus pixel data from the right one of the focus pixels (labeled with an “R”) representing light approaching from the right side of the pixel array 230. While the microlens 232 is shown within pixel array 230 as spanning left and right adjacent pixels/diodes (e.g., in a horizontal direction), this is for exemplary purposes only. A 2 pixel by 1 pixel microlens 232 may instead span top and bottom adjacent pixels/diodes (e.g., in a vertical direction), thus generating an up and down (or top and bottom) pair of focus photodiodes and corresponding pixel data.

Similarly, the microlens 242 of FIG. 2D covers a 2-pixel by 2-pixel square of four adjacent focus pixels of a pixel array 240, such that focus pixel data from all four photodiodes in the square may be generated. The focus pixel data from the four adjacent focus pixels thus includes focus pixel data from an upper-left pixel (labeled “UL” in FIG. 2D) representing light approaching from the upper-left of the pixel array 240, focus pixel data from an upper-right pixel (labelled “UR” in FIG. 2D) representing light approaching from the upper-right of the pixel array 240, focus pixel data from a bottom-left pixel (labeled “BL” in FIG. 2D) representing light approaching from the bottom-left of the pixel array 240, and focus pixel data from a bottom right pixel (labeled “BR” in FIG. 2D) representing light approaching from the bottom right of the pixel array 240. The configurations of pixel arrays 230 and 240 of FIG. 2C and FIG. 2D are exemplary; any number of focus pixels may be included within a pixel array, and may include one or more horizontally-oriented (left-right) 2-pixel by 1-pixel microlenses 232, one or more vertically-oriented (up-down) 2-pixel by 1-pixel microlenses 232, one or more 2-pixel by 2-pixel microlenses 242, or different combinations thereof.

Again referring to FIGS. 2C and 2D, once the pixel array captures a frame, thus capturing focus pixel data for each focus pixel, focus pixel data from paired focus pixels may be compared with one another. For example, focus pixel data from a left focus pixel photodiode may be compared with focus pixel data from a right focus pixel photodiode, and focus pixel data from a top focus pixel photodiode may be compared with focus pixel data from a bottom focus pixel photodiode. If the compared focus pixel data values differ, this difference is known as the phase disparity, also known as the phase difference, defocus value, or separation error. Focus pixels under a 2-pixel by 2-pixel microlens 242 as in FIG. 2D essentially have two vertically-adjacent horizontally-oriented pairs of focus pixels and/or two horizontally-adjacent vertically-oriented pairs of focus pixels. Thus, the focus pixel data from the UL focus pixel may be compared to focus pixel data from the BL focus pixel (as a top/bottom pair), focus pixel data from the UR focus pixel may be compared to focus pixel data from the BR focus pixel (as a top/bottom pair), focus pixel data from the UL focus pixel may be compared to focus pixel data from the UR focus pixel (as a left/right pair), focus pixel data from the BL focus pixel may be compared to focus pixel data from the BR focus pixel (as a left/right pair), or some combination thereof. In some cases, focus pixel data may alternately or additionally be compared between pixels that are opposite each other diagonally (along two axes). For example, focus pixel data from the UL focus pixel focus may be compared to focus pixel data from the BR focus pixel, and/or focus pixel data from the BL focus pixel focus may be compared to focus pixel data from the UR focus pixel.

While the focus pixels under the 2 pixel by 1 pixel microlens 232 of FIG. 2C and the focus pixels under the 2 pixel by 2 pixel microlens 242 of FIG. 2D are all illustrated having the color filter 212 of the first color, this is not required. In some cases, the normal pattern of the CFA of the pixel array may continue under a 2 pixel by 1 pixel microlens 232 and/or under a 2 pixel by 2 pixel microlens 242.

FIG. 2E illustrates a top-down view of a pixel array configuration of an image sensor in which at least one focus pixel has two photodiodes. In particular, a four-pixel by four-pixel pixel array 250 with four focus pixels is illustrated in FIG. 2E. The four focus pixels illustrated in the pixel array 250 each include two photodiodes, with the left-side photodiode and the right-side photodiode of each focus pixel's photodiode pair labeled “L” and “R,” respectively. Focus pixels with two photodiodes, like the focus pixels of FIG. 2E, are sometimes referred to as dual photodiode (2PD) focus pixels.

One of the 2PD focus pixels of FIG. 2E is labeled as 2PD focus pixel 252. The left-side photodiode (L) of the 2PD focus pixel 252 is labeled “left-side photodiode 254L,” and the right-side photodiode (R) of the 2PD focus pixel 252 is labeled “right-side photodiode 254R.” For each captured frame, the left photodiode 254L and the right photodiode 254R may capture light received by the 2PD focus pixel 252 from different angles. For a given frame, the data captured by the left photodiode 254L may be referred to as the left image or left image data, while the data captured by the right photodiode 254R may be referred to as the right image or right image data. The left image data and the right image data may be compared to determine phase disparity.

The pixel array 250 illustrated in FIG. 2E is a “sparse” 2PD pixel array in which only some of the pixels in the pixel array 250 include two photodiodes (namely, the focus pixels). The remaining pixels are imaging pixels and only include a single photodiode. In some cases, however a “dense” 2PD pixel array may be used instead, in which every pixel in the pixel array (or a higher percentage of pixels in the pixel array) include two photodiodes, and can in some cases act as both focus pixels and imaging pixels simultaneously, or can switch between acting as a focus pixel for one frame and acting as an imaging pixel for another frame. While all of the 2PD focus pixels of FIG. 2E are shown as “horizontal” 2PD focus pixels having a left photodiode and a right photodiode, this arrangement is exemplary. A pixel array with 2PD focus pixels may additionally or alternately include “vertical” focus pixels with a top (“up”) photodiode and a bottom (“down”) photodiode and/or photodiodes that are arranged diagonally with respect to one another. Since use of only horizontal focus pixels can sometimes limit recognition of horizontal edges in images, and use of only vertical focus pixels can sometimes limit recognition of vertical edges in images, use of both horizontal focus pixels and vertical focus pixels can improve focus quality by performing well even in images with many horizontal edges and/or vertical edges.

FIG. 2F illustrates a top-down view of a pixel array configuration of an image sensor in which at least one focus pixel has four photodiodes. The pixel array 260 illustrated in FIG. 2F includes focus pixels in which each focus pixel includes four diodes, generally referred to as 4PD focus pixels or Quadrature Phase Detection (QPD) focus pixels. For example, a 4PD focus pixel 262 is labeled in FIG. 2F, and includes an upper-left photodiode labeled with the letters “UL,” an upper-right photodiode labeled with the letters “UR,” a bottom-left photodiode labeled with the letters “BL,” and a bottom-right photodiode labeled with the letters “BR.” Data from each photodiode of the 4PD focus pixel 262 may be compared to data from an adjacent photodiode of the 4PD focus pixel 262 to determine phase difference. For example, photodiode data from the UL photodiode may be compared to photodiode data from the BL photodiode (as a top/bottom pair), photodiode data from the UR photodiode may be compared to photodiode data from the BR photodiode (as a top/bottom pair), photodiode data from the UL photodiode may be compared to photodiode data from the UR photodiode (as a left/right pair), photodiode data from the BL photodiode may be compared to photodiode data from the BR photodiode (as a left/right pair), or some combination thereof. In some cases, photodiode data from the 4PD focus pixel 262 may alternately or additionally be compared between photodiodes that are opposite each other diagonally (along two axes). For example, photodiode data from the UL photodiode of the 4PD focus pixel 262 may be compared to photodiode data from the BR photodiode of the 4PD focus pixel 262, and/or photodiode data from the BL photodiode of the 4PD focus pixel 262 may be compared to photodiode data from the UR photodiode of the 4PD focus pixel 262.

The pixel array 260 illustrated in FIG. 2F is a “sparse” 4PD pixel array in which only some of the pixels in the pixel array 260 include four photodiodes (namely, the focus pixels). The remaining pixels are imaging pixels and only include a single photodiode. In some cases, however a “dense” 4PD pixel array may be used instead, in which every pixel in the pixel array (or a higher percentage of pixels in the pixel array) include four photodiodes, and can in some cases act as both focus pixels and imaging pixels simultaneously, or can switch between acting as a focus pixel for one frame and acting as an imaging pixel for another frame. While all of the 4PD focus pixels of FIG. 2F are shown as “horizontal” 4PD focus pixels having a left photodiode and a right photodiode, this arrangement is exemplary. A pixel array with 4PD focus pixels may additionally or alternately include “vertical” focus pixels with a top (“up”) photodiode and a bottom (“down”) photodiode and/or photodiodes that are arranged diagonally with respect to one another. Since use of only horizontal focus pixels can sometimes limit recognition of horizontal edges in images, and use of only vertical focus pixels can sometimes limit recognition of vertical edges in images, use of both horizontal focus pixels and vertical focus pixels can improve focus quality by performing well even in images with many horizontal edges and/or vertical edges.

In some cases, a pixel array may use some combination of one or more pairs of focus pixels with masks 220 (as illustrated in FIG. 2A), one or more pairs of focus pixels covered by 2-pixel by 1-pixel microlenses 232 (as illustrated in FIG. 2C), one or more groups of focus pixels covered by 2-pixel by 2-pixel microlenses 242 (as illustrated in FIG. 2D), one or more 2PD focus pixels 252 (as illustrated in FIG. 2E), and/or one or more 4PD focus pixels 262 (as illustrated in FIG. 2F). In some cases, focus pixels in any of the configurations illustrated in and discussed with respect to FIG. 2A-2F may be arranged in a vertically and/or horizontally tiled pattern, such as the tiled patterns of the 2PD and 4PD focus pixels of FIG. 2E and FIG. 2F.

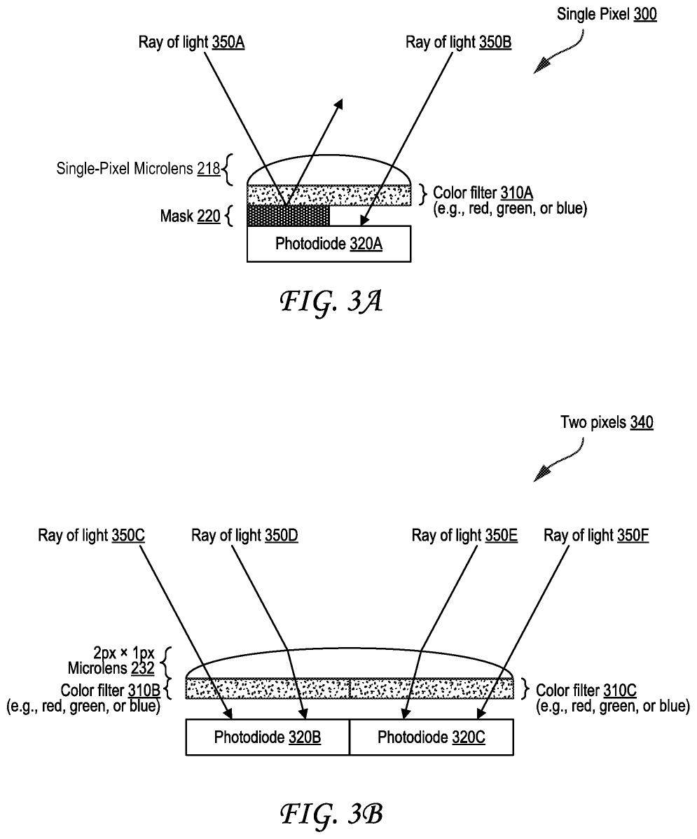

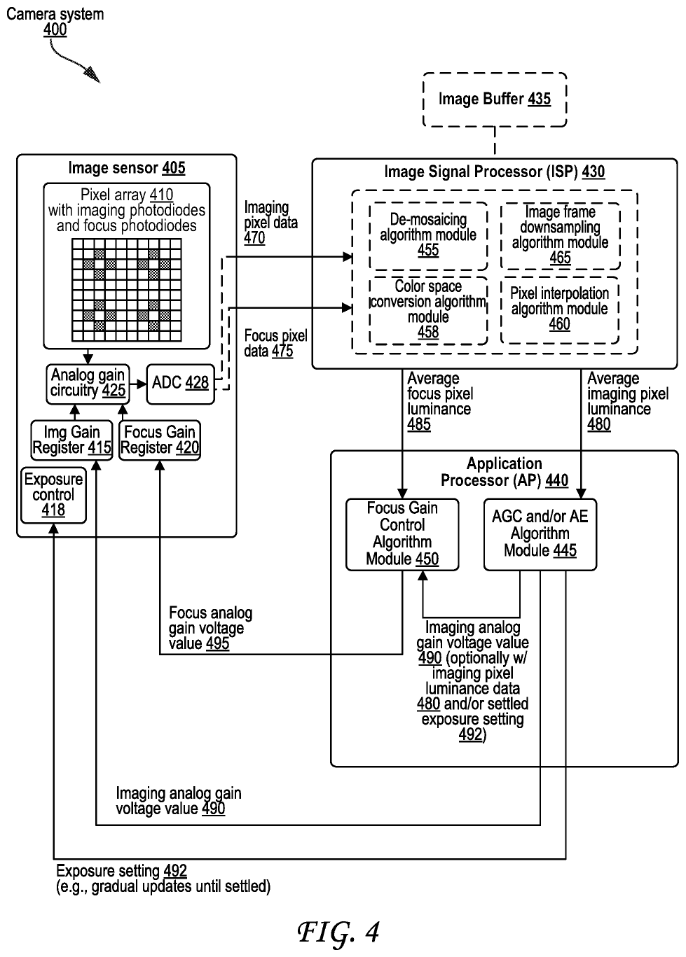

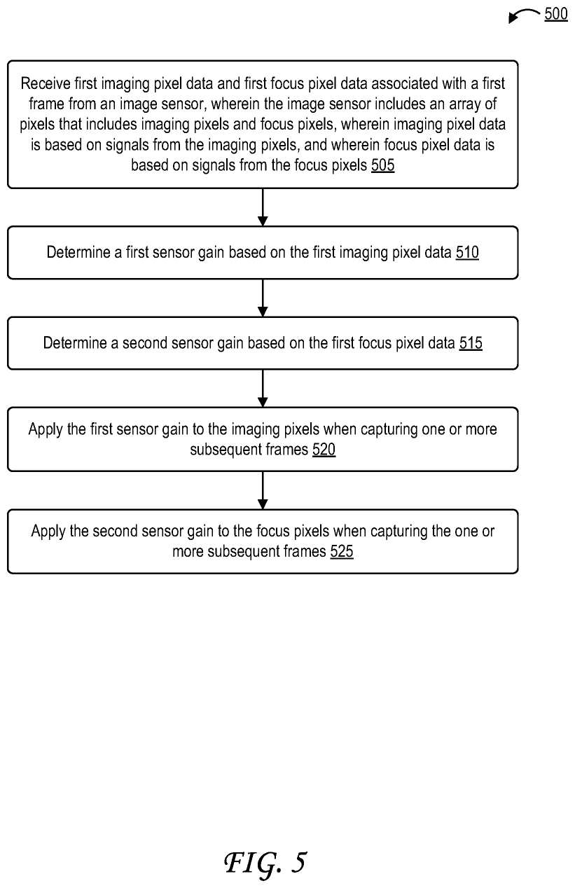

FIG. 3A illustrates a side view of a single pixel of a pixel array of an image sensor that is partially covered with a mask. The side view of the pixel 300 illustrates the single-pixel microlens 218 over a color filter 310A, which is over a mask 220, the mask 220 covering the left side of the photodiode 320A. A ray of light 350B entering from the right side of the microlens 218 passes through the color filter 310A and reaches the photodiode 320A, while ray of light 350A entering from the left side of the microlens 218 is reflected by the mask 220. While a similar pixel with the mask 220 over the right side of the photodiode 320A is not illustrated, it should be understood that this could be achieved by horizontally flipping the illustration of FIG. 3A. In an alternate embodiment, the mask 220 may be positioned above the color filter 310A and/or above the microlens 218.

FIG. 3B illustrates a side view of two pixels of a pixel array of an image sensor, the two pixels covered by a 2 pixel by 1 pixel microlens. The side view of the two pixels 340 of FIG. 3B illustrates the 2 pixel by 1 pixel microlens 232 over one color filter 310B on the left and another adjacent color filter 310C on the right, with the color filter 310B on the left over a left photodiode 320B, and the color filter 310C on the right over a right photodiode 320C. Two rays of light 350C and 350D entering from the left side of the microlens 232 pass through the left color filter 310B and reach the left photodiode 320B, while two rays of light 350E and 350F entering from the right side of the microlens 232 pass through the right color filter 310C and reach the right photodiode 320C.

Each color filter of the color filters 310A, 310B, and 310C of FIG. 3A and FIG. 3B may be a color filter of any color previously described with respect to color filters 212, 214, and 216. That is, while FIG. 3A and FIG. 3B list red, green, and blue as example colors to adhere to the traditional Bayer color scheme, each color filter of the color filters 310A, 310B, and 310C may represent another color such as cyan, yellow, magenta, emerald, or white (transparent). While the color filters 310A, 310B, and 310C all are illustrated with an identical pattern in FIG. 3A and FIG. 3B, the pattern matching the pattern of color filter 212 of FIGS. 2A-2D, the three color filters 310A, 310B, and 310C need not all represent the same color of color filter as each other, and need not represent the same color as the color filter 212 of FIGS. 2A-2D. All three color filters 310A, 310B, and 310C can be different colors, or alternately any two (or all three) can optionally share a color. Alternatively, no color filter may be included.

FIG. 4 is a block diagram illustrating a camera system that applies different analog gain to imaging pixel data and focus pixel data. The camera system 400 includes an image sensor 405, an image signal processor (ISP) 430, an optional image buffer 435 that provides buffer space usable by any of the algorithm modules of the ISP 430, and an application processor (AP) 440. The image sensor 405 includes a pixel array 410 including imaging pixels and focus pixels. The pixel array 410 includes an array of photodiodes, the array of photodiodes including imaging photodiodes associated with the imaging pixels and focus photodiodes associated with the focus pixels. The pixel array 410 is illustrated as a 10 pixel by 10 pixel array having a vertically and horizontally tiled pattern of focus pixels (shaded in grey) that form a in a 5 pixel by 5 pixel cross arrangement, with the pixel array 410 including imaging pixels (shaded in white) anywhere in the pixel array 410 that does not include focus pixels. The image sensor 405 also includes analog gain circuitry 425, an imaging gain register 415, a focus gain register 420, an exposure control 418, and an analog to digital converter (ADC) 428. While the exposure control 418 of FIG. 4 is illustrated as part of the image sensor 405, it may instead be part of a separate mechanism controlling exposure. The analog gain circuitry 425 amplifies the output signals of each of the photodiodes of the pixel array 410 in the analog space; that is, before the photodiode outputs are converted from analog data to digital data by the ADC 428. The signal amplification is measured in decibels (dB).

The analog gain circuitry 425 may include one or more amplifiers, such as one or more programmable gain amplifiers (PGAs), one or more variable gain amplifiers (VGAs), one or more other types amplifiers that apply a gain that may be programmed or modified, or some combination thereof. The one or more amplifiers of the analog gain circuitry 425 may apply different gain to focus pixel data from focus pixels of the pixel array 410 than the one or more amplifiers apply to imaging pixel data from imaging pixels of the pixel array 410. The gain applied by the one or more amplifiers of the analog gain circuitry 425 may, for example, be modified or programmed according to values in the imaging gain register 415 and/or in the focus gain register 420. If the imaging gain register 415 and the focus gain register 420 do not store any values, the one or more amplifiers of the analog gain circuitry 425 may amplify the signal outputs of each of the photodiodes of the pixel array 410 evenly by a predetermined default analog gain value N₁ (also referred to as an initial analog gain value N₁), which may in some cases optionally effect a minimal amplification or no amplification of each of the photodiode outputs as the predetermined default value N₁. If the imaging gain register 415 stores a value, then the analog gain circuitry 425 may amplify the outputs of each of the imaging photodiodes of the pixel array 410 evenly by a voltage corresponding to the value in the imaging gain register 415. If the focus gain register 420 includes a value, then the analog gain circuitry 425 may amplify the outputs of each of the focus photodiodes of the pixel array 410 evenly by a voltage corresponding to the value in the focus gain register 420; otherwise, the analog gain circuitry 425 may amplify the signal outputs of each of the focus photodiodes of the pixel array 410 evenly by applying a voltage corresponding to the value in the imaging gain register 415. In some cases, the imaging gain register 415 and/or the focus gain register 420 may always store a value; in such cases, the imaging gain register 415 and/or the focus gain register 420 store the predetermined default value N₁ unless and until those values are modified. Once amplified by the analog gain circuitry 425, the outputs of the photodiodes of the pixel array 410 are converted from analog signals to digital signals by the ADC 428, optionally amplified again via digital gain (not shown), and sent from the image sensor 405 to the ISP 430. The image sensor 405 of FIG. 4 is illustrated sending the imaging pixel data 470 to the ISP 430, and also sending the focus pixel data 475 to the ISP 430. In some cases, imaging pixel data 470 may alternately be referred to as imaging photodiode data 470. In some cases, focus pixel data 475 may alternately be referred to as focus photodiode data 475.

The imaging gain register 415 and the focus gain register 420, are referred to as registers and may more specifically be frame boundary registers of the image sensor 405, or may alternately be any other type of memory 1115 as discussed with respect to FIG. 11. Likewise, the exposure control 418 may be or may include one or more frame boundary registers or other types of registers of the image sensor 405, or may alternately be any other type of memory 1115 as discussed with respect to FIG. 11. The imaging gain register 415, the focus gain register 420, and the exposure control 418 may be part of the image sensor 405 as illustrated in FIG. 4, or may be outside of the image sensor 405, for example as part of the ISP 430, image buffer 435, the AP 440, or a unit or device of memory 1115 associated with any one of, or any combination of, the image sensor 405, the ISP 430, image buffer 435, and/or the application processor 440. The analog gain circuitry 425, while illustrated as a separate block from the pixel array 410, may actually be (at least in part) integrated as part of the pixel array 410. The analog gain circuitry 425 may include one or more programmable gain amplifiers (PGAs), such as operational amplifiers (op amps). The analog gain circuitry 425 may alternately or additionally include one or more source follower transistors or common drain amplifiers. The analog gain circuitry 425 may in some cases be applied after application of an initial conversion gain circuitry that converts photodiode electron charge to a voltage. Analog noise suppression or noise reduction circuitry may be applied before and/or after analog gain. The analog gain circuitry 425 may be connected serially, in a column-parallel fashion, at the pixel circuitry directly (e.g., as in an active-pixel sensor (APS)), or some combination thereof. The analog gain circuitry 425 may include one or more operation amplifiers (op amps), one or more source follower transistors (common drain amplifiers), one or more other types of amplifiers, or some combination thereof. The image sensor 405 may be a complementary metal-oxide-semiconductor (CMOS) image sensor, a charge-coupled device (CCD) image sensor, or a hybrid CCD-CMOS image sensor that uses elements of a CCD image sensor and elements of a CMOS image sensor.

The ISP 430 receives imaging pixel data 470 and focus pixel data 475 corresponding to one or more frames captured by the image sensor 405, usually (but not necessarily) one frame at a time. The imaging pixel data 470 and focus pixel data 475 is typically still in the color filter domain—that is, data for each pixel is still measured in the form of signals from one or more photodiodes that are under differently-colored color filters, the signals optionally having been amplified via the analog gain circuitry 425 and converted from analog signals to digital signals via the ADC 428. A de-mosaicing algorithm module 455 of the ISP 430 may de-mosaic the imaging pixel data 470, which reconstructs a color image frame from the color photodiode data output from the color-filter-overlaid photodiodes of the pixel array 410 of the image sensor. The color image frame reconstructed by the de-mosaicing may be in an RGB color space, a cyan magenta yellow (CMY) color space, a cyan magenta yellow key (black) (CMYK) color space, a CYGM color space, an RGBE color space, a luminance (Y) chroma (U) chrome (V) (YUV) color space, or any combination thereof, in some cases depending on the color filters used in the CFA of the pixel array 410 of the image sensor 405. The de-mosaicing algorithm module 455 of the ISP 430 modifies the imaging pixel data 470 by de-mosaicing the image pixel data 470 and thus converting the imaging pixel data 470 from the color filter color space (e.g., Bayer color space) to a different color space, such as the RGB color space, the YUV color space, or another color space listed above or discussed otherwise herein, such as with respect to the color space conversion algorithm module 458. While the de-mosaicing algorithm module 455 is illustrated in the ISP 430, in some cases it may be performed in the image sensor 405 itself.

The imaging pixel data 470 that is output by the image sensor 405 or by the de-mosaicing algorithm module 455 can further be manipulated in the ISP 430. In some cases, the color space conversion algorithm module 458 of the ISP 430 may additionally convert the color space of the imaging pixel data 470 and/or focus photodiode/pixel data 475 between any of the color spaces discussed above with respect to the de-mosaicing algorithm module 455. For example, the color space conversion algorithm module 458 may convert the imaging pixel data 470 from the RGB color space (e.g., if the CFA of the image sensor 405 uses traditional red, green, and blue Bayer filters) to the YUV color space, which represents each pixel with a luminance (or “luma”) value Y and two chroma values U and V. The luminance value Y in the YUV color space represents achromatic brightness or luminance of a pixel, from black (zero luminance) to white (typically 255 luminance). The two chroma values U and V represent coordinates in a 2-dimensional U-V color plane.

The ISP 430 also includes a pixel interpolation algorithm module 460. The pixel interpolation algorithm module 460 takes, as its input, either the imaging pixel data 470 from the image sensor 405, or the imaging pixel data 470 from the de-mosaicing algorithm module 455. For example, in some cases, the pixel interpolation algorithm module 460 may modify the imaging pixel data 470 before de-mosaicing using the de-mosaicing algorithm module 455, while in other cases, the pixel interpolation algorithm module 460 may modify the imaging pixel data 470 after de-mosaicing using the de-mosaicing algorithm module 455. Reference to the imaging pixel data 470 herein, in the context of the pixel interpolation algorithm module 460, should thus be interpreted to refer to the imaging pixel data 470 either before or after de-mosaicing via the de-mosaicing algorithm module 455.

If the input to the pixel interpolation algorithm module 460 is the imaging pixel data 470 before de-mosaicing via the de-mosaicing algorithm module 455, that imaging pixel data 470 will still include data from individual photodiodes in the color filter space, as each of the photodiodes may be under a color filter as illustrated in and discussed with respect to FIGS. 2A-2F and FIGS. 3A-3B. In this case, the imaging pixel data 470 may have missing or incorrect data corresponding to the positions of focus photodiodes or focus pixels in the pixel array 410. In such cases, the pixel interpolation algorithm module 460 identifies data from one or more imaging photodiodes that are adjacent to or neighboring the focus photodiode (e.g., within a N₂-photodiode radius of focus photodiode, where N₂ is for example 1, 2, 3, 4, 5, 6, 7, 8, 9, or 10). The neighboring photodiodes may be limited to those that are covered by the same color of color filter as the focus photodiode corresponding to the missing or incorrect data in the imaging pixel data 470. The pixel interpolation algorithm module 460 interpolates a value for the focus photodiode—which is then used to generate pixel data during de-mosaicing—based on these the values of these neighboring pixels, for example by averaging values from the one or more neighboring imaging photodiodes.

If the input to the pixel interpolation algorithm module 460 is the imaging pixel data 470 after de-mosaicing via the de-mosaicing algorithm module 455, the imaging pixel data 470 is in one of the other color spaces discussed with respect to the de-mosaicing algorithm module 455 and/or the color space conversion algorithm module 458. The imaging pixel data 470 may have missing or incorrect data corresponding to the positions of focus pixels in the pixel array 410. In such cases, the pixel interpolation algorithm module 460 may identify one or more imaging pixels that are adjacent to or neighboring the focus pixel (or within a N₃-pixel radius of the focus pixel, where N₃ is for example 1, 2, 3, 4, 5, 6, 7, 8, 9, or 10). The pixel interpolation algorithm module 460 may interpolate one or more values (depending on the color space and on the color of color filter that was over the focus photodiode) for the “missing” or “incorrect” pixel. The pixel interpolation algorithm module 460 may interpolate the incorrect pixel data by averaging values from the one or more neighboring imaging pixels. For example, a pixel generated without focus pixel data 475 where the focus photodiode was under a green color filter will have zero green—which the pixel interpolation algorithm module 460 may fill in with a higher amount of green depending on how much green the adjacent or neighboring pixels have. In some cases, the pixel interpolation algorithm module 460 may also receive the focus pixel data 475, which the pixel interpolation algorithm module 460 may use as part of the interpolation. For example, if a focus photodiode under a green color filter is in a position, that, in the context of the entire frame, depicts a green-saturated area such as a grassy field, then the pixel interpolation algorithm module 460 may be able to confirm whether to interpolate a similar green to neighboring pixels based on whether the focus photodiode received any green light, even if the amount is lower than neighboring pixels have.

The ISP 430 also includes an image frame downsampling algorithm module 465 that can downsample the imaging pixel data 470, for example through binning, decimation, subsampling, or a combination thereof. For example, if the image sensor 405 has a pixel array corresponding to an image frame of a large size, such as 10 megapixels (MP), the image frame downsampling algorithm module 465 may downsample the image to a smaller size, such as a 50 pixel by 50 pixel frame, which is easier to manage and manipulate. In some cases, the image frame downsampling algorithm module 465 may downsample the image frame (or downsample again an already-downsampled version of the image frame) to a single pixel, thus essentially generating an “average” pixel. If converted to the YUV color scale before or after such a downsampling, the “average” pixel can represent average luminance and average chroma (color).

The ISP 430 can apply the de-mosaicing algorithm module 455, the color space conversion algorithm module 458, the pixel interpolation algorithm module 460, and the image frame downsampling algorithm module 465 to the imaging pixel data 470 in any order. In one example, the pixel interpolation algorithm module 460 is applied before the de-mosaicing algorithm module 455 to correct missing data as early as possible (i.e., in the original color filter color space), which is applied to the imaging pixel data 470 before the color space conversion algorithm module 458 and/or the image frame downsampling algorithm module 465. In another example, the de-mosaicing algorithm module 455 is applied before the pixel interpolation algorithm module 460, as some color spaces may be better suited to pixel interpolation than others. In one example, the pixel interpolation algorithm module 460 and the de-mosaicing algorithm module 455 are applied before the image frame downsampling algorithm module 465 so that downsampling does not use the missing or incorrect pixel data (unless the missing or incorrect pixel data is removed through decimation). The color space conversion algorithm module 458 can be applied multiple times in some cases, and in some cases can occur before and/or after application of the pixel interpolation algorithm module 460. The color space conversion algorithm module 458 can be applied before and/or after application of the image frame downsampling algorithm module 465. In some cases, the ISP 430 also performs other image processing functions before sending the average imaging pixel luminance 480 and average focus pixel luminance 485, such as black level adjustments, white balance, lens shading, and lens rolloff correction. In other cases, the AP 440 performs such other image processing functions after receiving the average imaging pixel luminance 480 and/or average focus pixel luminance 485, such as black level adjustments, white balance, lens shading, and lens rolloff correction.

The ISP 430 can output average imaging pixel luminance 480 to an automatic gain control (AGC) and/or automatic exposure (AE) control algorithm module 445 of the application processor 440. The average imaging pixel luminance 480 can include the luminance (e.g., the “Y” value in YUV color space) of the single average pixel value described above with respect to the downsampling algorithm module 465—that is, the average luminance of the entire imaging frame, which may have been determined also based on pixels interpolated by the pixel interpolation algorithm module 460. The AGC and/or AE Algorithm Module 445 can compare this average imaging pixel luminance 480 to a predetermined imaging target luminance value or range. The predetermined imaging target luminance value or range can be selected based on luminance values that are typically visually pleasing, clear, and not washed out due to dimness or bright light.

The AGC and/or AE Algorithm Module 445 can be used to adjust the exposure and/or the imaging analog gain voltage value 490. Note that the terms “exposure” and “exposure setting” as used herein may in some cases refer to exposure time, aperture size, ISO, imaging analog gain, focus analog gain, imaging digital gain, focus digital gain, or some combination thereof. As discussed herein, adjusting exposure, or adjusting an exposure setting, may thus involve adjusting one or more of the exposure time, aperture size, ISO, imaging analog gain, focus analog gain, imaging digital gain, or focus digital gain.

If the average imaging pixel luminance 480 for a frame is more than a predetermined range away from the predetermined imaging target luminance value or from the boundaries of the predetermined imaging target luminance range, then the frame is characterized by a low-light or high-light condition. As discussed herein, this frame will be referred to as the initial frame. If the initial frame has a low-light or high-light condition, the AGC and/or AE Algorithm Module 445 can adjust the exposure and/or the imaging analog gain voltage value 490 to move the average imaging pixel luminance 480 toward the imaging target luminance value or toward a value falling within or on the boundary of the predetermined imaging target luminance range. The adjustment of the exposure and/or the imaging analog gain voltage value 490 may only impact a later frame received from the pixel array 410 after the initial frame.

In some cases, the AGC and/or AE Algorithm Module 445 first adjusts the exposure until the average imaging pixel luminance 480 within a predetermined difference of the imaging target luminance value or range, at which point the exposure is considered settled. The AGC and/or AE Algorithm Module 445 only then begins adjusting the imaging analog gain voltage value 490 until the average imaging pixel luminance 480 reaches the imaging target luminance value or range. Exposure is adjusted first because adjusting exposure has no effect on noise, while changes to the imaging analog gain voltage value 490 generally increase noise and are thus better reserved for smaller adjustments. Because the effects of exposure adjustments can be difficult to predict, exposure is often adjusted over multiple frames, with the exposure changing gradually with each frame. The AGC and/or AE Algorithm Module 445 can send exposure settings 492 to the exposure control 418 of the image sensor 405 with each update to the exposure, including the final update that results in settled exposure.

As an example, if the average imaging pixel luminance 480 in the initial frame is 5, and a predetermined imaging target luminance range is 50 to 60, then the AGC and/or AE Algorithm Module 445 of the AP 440 can increase exposure (e.g., by increasing exposure time, aperture, ISO) gradually by sending an updated exposure setting to the exposure control 418. The increase in increase in exposure from the updated exposure setting is applied at a second frame after the initial frame, and in this example increases the average imaging pixel luminance 480 from 5 up to 20. The AGC and/or AE algorithm module 445 of the AP 440 can increase exposure gradually again. At a third frame after the second frame, the second increase in exposure increases the average imaging pixel luminance 480 from 20 up to 46. The average imaging pixel luminance 480 of 46 is within a small range (4) of the lower boundary (50) of the predetermined imaging target luminance range. This small range (4) may be less than a predetermined threshold difference, which in this example may be 5. Because the average imaging pixel luminance 480 is less than the predetermined threshold difference from the lower boundary (50) of the predetermined imaging target luminance range, the AGC and/or AE algorithm module 445 deems the exposure setting 492 to be settled. The AGC and/or AE algorithm module 445 then increase the imaging analog gain voltage value 490 to increase the average imaging pixel luminance 480 from 46 up to 50, thus reaching the lower boundary (50) of the predetermined imaging target luminance range. The AGC and/or AE algorithm module 445 can set the imaging analog gain voltage value 490 to an analog gain voltage value corresponding to a 1.087× multiplier (50/46=1.087).

The imaging analog gain voltage 490 may be determined as a multiple of a default analog gain voltage for the image sensor 405, and based on its proportion to the default analog gain voltage for the image sensor 405, may act as a multiplier of the data from the imaging photodiodes. The multiplier can be determined by dividing a target luminance—which in the example discussed above is the lower boundary (50) of the predetermined imaging target luminance range—by the current average imaging luminance (46). In some cases, the average imaging pixel luminance 480 may also include additional luminance information, such as average luminance of various regions of the imaging frame as determined based on Y values (in the YUV color space) in a downsampled frame generated by the image frame downsampling algorithm module 465. On the other hand, if the initial average imaging pixel luminance 480 is too high (e.g., above an upper bound of the luminance range), the exposure setting 492 may similarly be decreased (e.g., by decreasing exposure time, aperture, ISO, and/or in some cases gain) until it is settled and imaging pixel luminance 480 is within the luminance range or at the upper bound of the luminance range.

The focus gain control algorithm module 450 of the AP 440 receives average focus pixel luminance 485 from the ISP 430 and receives the imaging analog gain voltage value 490 from the AGC and/or AE algorithm module 445 of the AP 440. The focus gain control algorithm module 450 of the AP 440 can optionally also receive the average imaging pixel luminance 480 and/or the settled exposure setting 492 from the AGC and/or AE algorithm module 445 of the AP 440. The average focus pixel luminance 485 can be an average focus pixel luminance of the focus pixel data 475, calculated by the ISP 430 (or in some cases instead by the AP 440) by determining a sum of the luminance values (Y values in YUV color space) of each focus pixel output, then dividing the sum by the total number of focus pixels.

The focus gain control algorithm module 450 can compare this average focus pixel luminance 485 to a predetermined focus target luminance value or range. The predetermined focus target luminance value or range can be selected based on luminance values that typically maximize phase disparities, improve consistency in phase disparities, improve confidence in phase disparities, or some combination thereof.

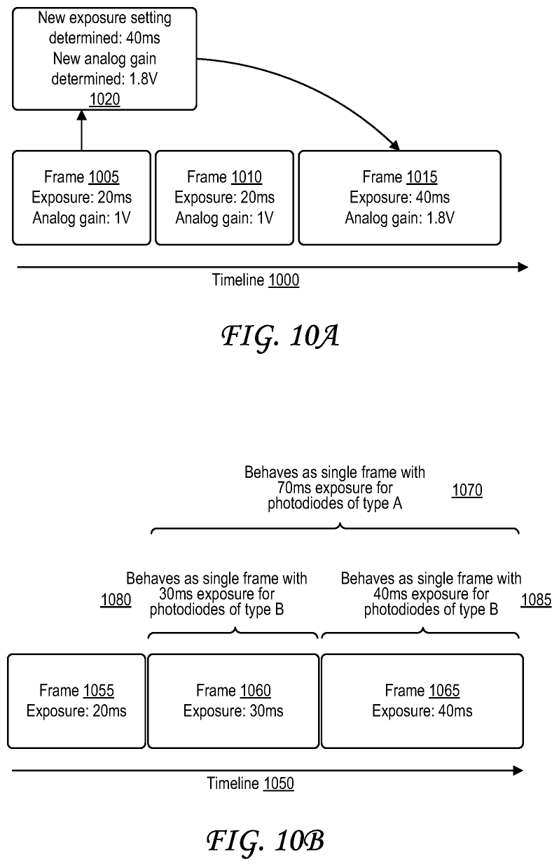

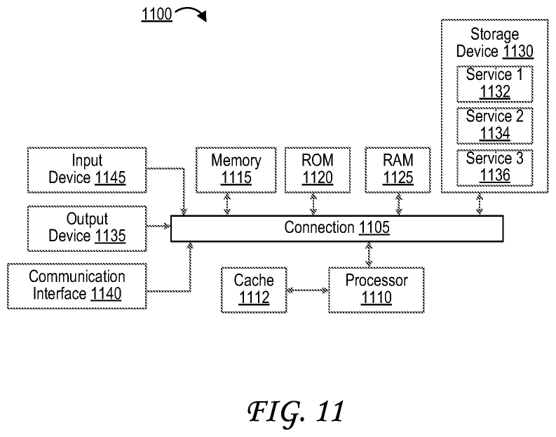

If the average focus pixel luminance 485 is more than a predetermined range away from the predetermined focus target luminance value or from the boundaries of the predetermined focus target luminance range, the focus gain control algorithm module 450 cannot adjust the exposure (except as discussed with respect to FIG. 10B), but it can adjust the focus analog gain voltage value 495. The focus gain control algorithm module 450 thus adjusts the focus analog gain voltage value 495 to move the average focus luminance toward the focus target luminance value or range.

An example may be helpful to illustrate the focus analog gain voltage value 495. While the terms “first frame,” and “second frame” are used in discussing this example, they do not refer to the same “first frame” and “second frame” discussed in the previous example for determining exposure. In this example, the average focus pixel luminance 485 for a first frame is 5, and a predetermined focus target luminance range is a range from 30 to 120. The focus gain control algorithm module 450 adjusts the focus analog gain voltage value 495 with the goal of increasing the average focus pixel luminance 485 from 5 up to 30, since 30 is the lower boundary of the range. The increase in average focus pixel luminance 485 from 5 up to 30 would only take effect in a second frame after the first frame. The focus gain control algorithm module 450 increases the average focus pixel luminance 485 from 5 to 30 by setting the focus analog gain voltage value 495 to an analog gain voltage value corresponding to a 6× multiplier, since 30/5=6.

The focus analog gain voltage 495 may be determined as a multiple of a default analog gain voltage for the image sensor 405, and based on its proportion to the default analog gain voltage for the image sensor 405, may act as a multiplier of the data from the focus pixels relative to a previously used focus gain. The previously used focus gain may be equivalent to the imaging gain or to another default focus gain, or to an intermediate focus gain value if the focus gain is gradually adjusted over multiple adjustment cycles. In the above-discussed example, the ratio of the target luminance (30) divided by the average focus pixel luminance at the first frame (5) may be multiplied by the previously used focus gain to determine the focus analog gain voltage 495 that will increase the average focus pixel luminance to 30 at the second frame. The focus analog gain voltage 495 may thus be determined as a multiple of the imaging analog gain voltage 490. The multiplier can be determined by dividing a target luminance—which in this example is the lower boundary (30) of the predetermined focus target luminance range—by the average focus luminance for a current frame, which in the example is 5. For example, focus gain can be determined as equal to Previous Focus Gain*(Focus Luminance Target/Average Focus Pixel Luminance). The focus gain control algorithm module 450 of the AP 440 then sends the focus analog gain voltage value 495 to the image sensor 405, which stores the focus analog gain voltage value 495 in the focus gain register 420, replacing any previous value stored in the focus gain register 420.

Once the focus gain register 420 is updated, another frame is captured. At this frame, data from the imaging photodiodes is amplified by the analog gain circuitry 425 according to the imaging analog gain voltage value 490 in the image gain register 415, and data from the focus photodiodes is amplified by the analog gain circuitry 425 according to the focus analog gain voltage value 495 in the focus gain register 420. One or more phase disparity values are calculated, either at the image sensor 405, ISP 430, or at the AP 440, based on the focus photodiode/pixel data 475, and in particular based on differences between focus photodiode/pixel data 475 from focus photodiodes receiving left-angled light and focus photodiode/pixel data 475 from focus photodiodes receiving right-angled light, and/or based on differences between focus photodiode/pixel data 475 from focus photodiodes receiving top-angled light and focus photodiode/pixel data 475 from focus photodiodes receiving bottom-angled light, and so forth. The phase disparity values may in some cases be averaged at the image sensor 405, ISP 430, or at the AP 440, and an instruction may be generated based on the average phase disparity for actuating one or more motors to move a lens of the camera from a first lens position to a second lens position, where the second lens position should correspond to, or be within a threshold distance of, an in focus state 150. Once the lens is moved to the second lens position, another frame is captured, and a focused image is generated by the ISP 430 using the imaging pixel data 470 and interpolated pixels generated by the pixel interpolation algorithm module 460.

In some cases, PDAF alone may not get the lens quite to an in-focus state 150; that is, the second lens position is not quite in an in-focus state 150. In this case, the image sensor 405, ISP 430, and/or AP 440 may further perform contrast detection auto focus (CDAF) after the lens is moved to the second lens position by actuating the one or more motors to move to each of a plurality of lens positions within a predetermined distance of the second lens position, and by identifying a focused lens position that maximizes contrast from the plurality of lens positions.

While the ISP 430 and AP 440 of the camera 400 are illustrated as separate components, in some cases these may be merged together into one processor, such as one ISP or AP or any processor type discussed with respect to processor 1110. In some cases, the ISP 430 and AP 440 of the camera 400 may be multiple such processors, but those processors may be organized differently than is illustrated in FIG. 4, with the various algorithm modules distributed differently, or each at a different processor, for example. In some cases, operations discussed herein as being performed at the image sensor 405 may instead be performed at the ISP 430 and/or AP 440. In some cases, operations discussed herein as being performed at the ISP 430 may instead be performed at the image sensor 405 and/or AP 440. In some cases, operations discussed herein as being performed at the AP 440 may instead be performed at the image sensor 405 and/or ISP 430. The image sensor 405, ISP 430, AP 440, or any other processor used herein may perform its various algorithm modules and other operations as described herein based on execution of instructions stored on a memory 1115 or other non-transitory computer-readable storage medium within the camera 400. The camera 400 may be or include one or more computing systems 1100 as illustrated in and discussed with respect to FIG. 11, and/or any components of a computing system 1100 that are illustrated in and/or discussed with respect to FIG. 11.

FIG. 5 is a flow diagram illustrating processing of image sensor data to determine and apply two sensor gains. The processing of data from an image sensor 405 in the operations 500 of FIG. 5 are performed by one or more processors upon execution of stored instructions by the one or more processors. The phrase “one or more processors” in the context of FIG. 4 may, for example, refer to the image signal processor (ISP) 430, the application processor (AP) 440, both, another processor 1110 not shown in FIG. 4, or a combination thereof.

At step 505, the one or more processors receive first imaging pixel data and first focus pixel data associated with a first frame from an image sensor. The image sensor includes an array of pixels that includes imaging pixels and focus pixels. Imaging pixel data is based on signals from the imaging pixels, while focus pixel data is based on signals from the focus pixels.

At step 510, the one or more processors determine a first sensor gain based on the first imaging pixel data. At step 515, the one or more processors a second sensor gain based on the first focus pixel data. At step 520, the one or more processors apply the first sensor gain to the imaging pixels when capturing one or more subsequent frames. At step 525, the one or more processors apply the second sensor gain to the focus pixels when capturing the one or more subsequent frames.

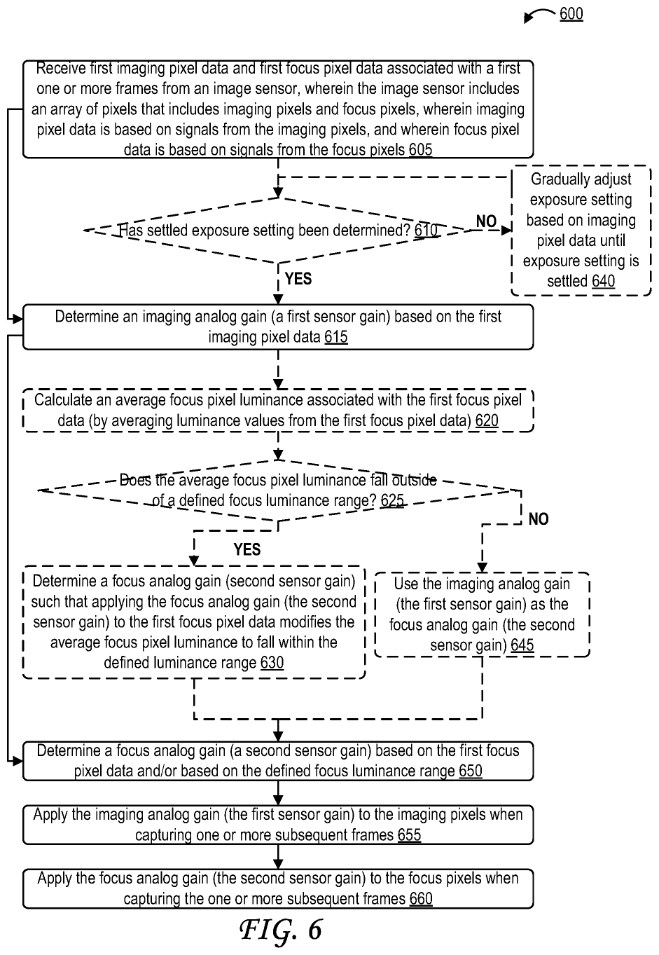

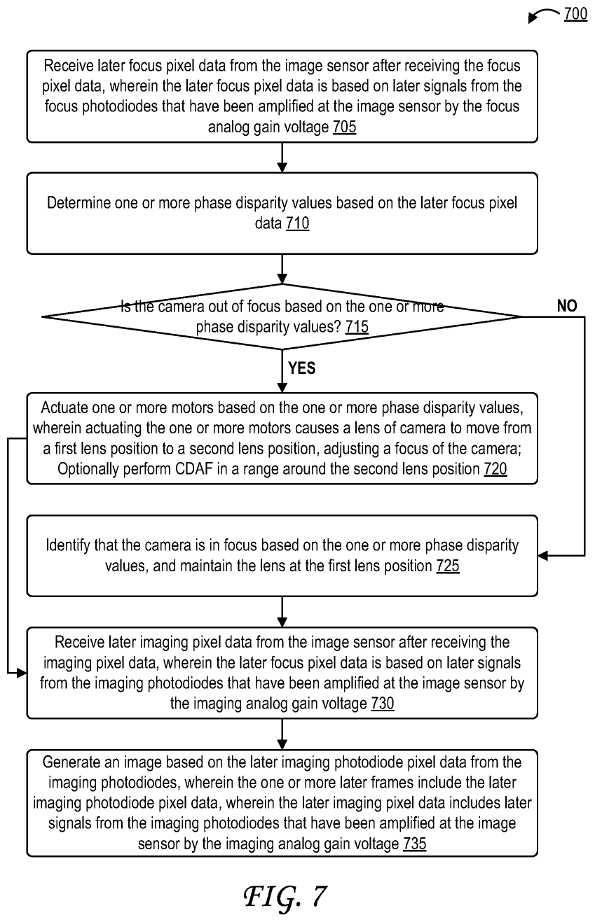

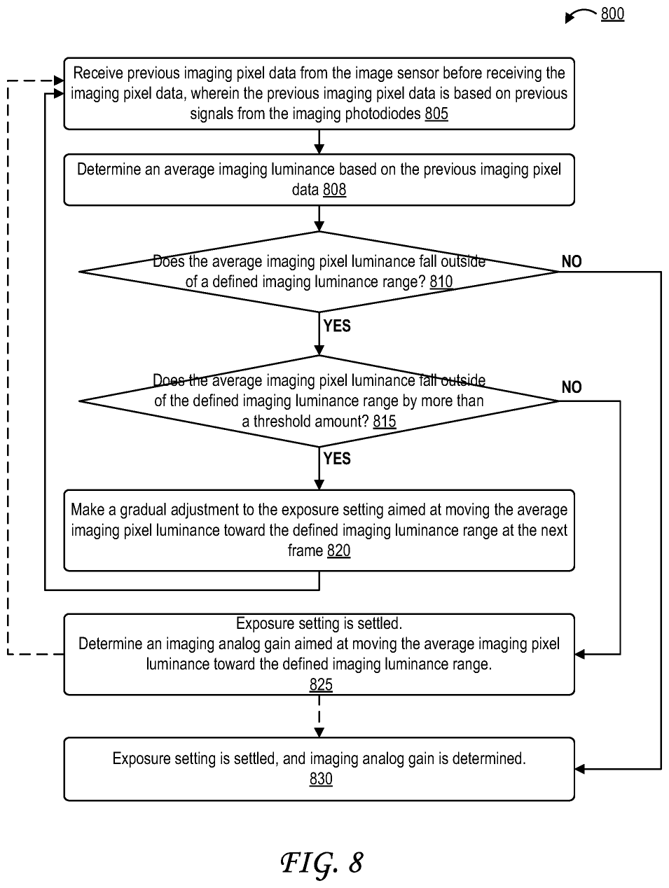

FIG. 6 is a flow diagram illustrating processing of image sensor data to determine an imaging analog gain voltage for imaging pixel data and a focus analog gain voltage for focus pixel data based on luminance. The operations 600 of FIG. 6 represent a specific implementation of the operations 500 of FIG. 5. The processing of data from an image sensor 405 in the operations 600 of FIG. 6 are performed by one or more processors upon execution of stored instructions by the one or more processors. The phrase “one or more processors” in the context of FIG. 4 may, for example, refer to the image signal processor (ISP) 430, the application processor (AP) 440, both, another processor 1110 not shown in FIG. 4, or a combination thereof.

At step 605, the one or more processors receive first imaging pixel data 470 and first focus pixel data 475 associated with a first frame (named “first” here for ease of reference—the first frame need not be the first/earliest in any particular sequence of frames) from an image sensor 405 of a camera 400. The image sensor 405 may include an array of photodiodes (as part of the pixel array 410) that includes imaging photodiodes and focus photodiodes. Imaging pixel data 470 is based on signals from the imaging photodiodes, optionally amplified at the analog gain circuitry 425 based on an imaging gain value stored in the imaging gain register 415. The first focus pixel data 475—and all focus pixel data 475—is based on signals from the focus photodiodes, optionally amplified at the analog gain circuitry 425 based on an imaging gain value stored in the imaging gain register 415.

At step 610, the one or more processors optionally identify whether a settled exposure setting 492 has been determined. If a settled exposure setting 492 has been determined, for example as in step 825 or step 830 of FIG. 8, then the settled exposure setting 492 was already applied to the one or more frames received at step 605, and step 615 follows step 610. If a settled exposure setting 492 has not been determined, step 640 follows step 610. At step 640, the exposure setting is gradually adjusted based on the imaging pixel data 470 over the course of one or more frames until the exposure setting is finally settled, which is determined when an average imaging pixel luminance 480 that is based on the imaging pixel data 470 approaches (over one or more frames) a target imaging luminance (either a threshold or a value within or at a boundary of a target range) and eventually reaches, moves to the other side of, or lands within a predetermined range of the target imaging luminance. The defined imaging luminance threshold, or lower and upper boundaries of the defined imaging luminance range, may represent average luminance values that generally produce visually pleasing images based on characteristics of the image sensor 405 such as noise, saturation and/or color response. The lower and upper boundaries of the defined imaging luminance range may be either considered within the defined imaging luminance range or outside of the defined imaging luminance range. Step 640 is explored further in the operations 800 of FIG. 8, the gradual adjustments to exposure of step 820 resulting in a loop back to step 805 until the exposure is settled at step 825 or step 830.

At step 615, the one or more processors determine an imaging analog gain voltage 490 (which may be referred to as a first sensor gain) based on the imaging pixel data 470. More specifically, an average imaging pixel luminance 480 is determined by the ISP 430 from the imaging pixel data 470. The imaging pixel data 470 is optionally be run through the pixel interpolation algorithm module 460 to interpolate missing or incorrect data at focus pixel positions and de-mosaiced as discussed with respect to the de-mosaicing algorithm module 455 of FIG. 4, and can optionally be run through the color space conversion algorithm module 458 and/or the image frame downsampling algorithm module 465, in any order. The imaging analog gain voltage 490 is determined by the AGC and/or AE algorithm module 445 of the AP 440 so that any remaining gap between the average imaging pixel luminance 480 and a target imaging luminance (either a defined threshold or a value within or at a boundary of a defined target range) is bridged at the next frame captured by the image sensor 405 via amplification of the next frame of imaging pixel data 470 by the imaging analog gain voltage 490. The imaging analog gain voltage 490 may be determined as a multiple of a default analog gain voltage for the image sensor 405, and based on its proportion to the default analog gain voltage for the image sensor 405, may act as a multiplier of the data from the imaging photodiodes. The multiplier may be determined by dividing the target imaging luminance by the average imaging luminance. For example, imaging analog gain can be determined as equal to Previous Imaging Gain*(Imaging Luminance Target/Average Imaging Pixel Luminance).

In some cases, the first focus pixel data discussed with respect to step 605 may be from a later frame than the first imaging pixel data discussed with respect to step 605, and may be received after step 615 but before steps 620, 625, 630, 645, 650, 655, and 660. In other cases, the first focus pixel data and first imaging pixel data may be from the same frame.

At step 620, the one or more processors calculate an average focus pixel luminance 485 by averaging luminance values from the focus pixel data 475. At step 625, the one or more processors identify whether the average pixel focus luminance 485 falls outside of a defined focus luminance range. The lower and upper boundaries of the defined focus luminance range may represent average luminance values at which phase disparity is generally consistent across the image sensor, which may be based on characteristics of the image sensor 405 such as noise, saturation, and/or color response. If the average pixel focus luminance 485 falls outside of the defined focus luminance range, step 625 is followed by step 630. If the average focus pixel luminance 485 does not fall outside of the defined focus luminance range (and instead falls within the defined focus luminance range), step 625 is followed by step 645. The lower and upper boundaries of the defined focus luminance range may be either considered within the defined focus luminance range or outside of the defined focus luminance range. In some cases, instead of the defined luminance range of step 625, there is only a threshold corresponding to a minimum luminance (similar to the lower bound of a range with no upper bound) or to a maximum luminance (similar to the upper bound of a range with no lower bound). At step 645, the one or more processors set the focus analog gain voltage 495 (as stored in the focus gain register 420) to the value of the imaging analog gain voltage 490 (by sending that value to the focus gain register 420) for the purposes of determining phase disparity as discussed further with respect to FIG. 7, and as discussed previously with respect to FIG. 4. Step 645 may alternately store a different previous focus analog gain value, as the current focus analog gain value, for example an intermediate focus gain value if the focus gain is gradually adjusted over multiple adjustment cycles.

At step 630, the one or more processors determine a focus analog gain voltage 495 such that applying the focus analog gain (the second sensor gain) to the first focus pixel data modifies the average focus pixel luminance to fall within the defined luminance range. That is, a second average focus pixel luminance 485, calculated by averaging the data signals from the focus photodiodes (either the same signals from the focus photodiodes as in the focus pixel data of step 605 or later-received data signals from the focus photodiodes), when amplified by the focus analog gain voltage 495 and averaged into a second average focus luminance, falls within the defined focus luminance range. The focus analog gain voltage 495 is therefore calculated so as to push the second average focus pixel luminance 485 toward a boundary of the defined focus luminance range. The focus analog gain voltage 495 is may optionally be calculated to bring the second average focus pixel luminance 485 into the defined focus luminance range hypothetically without actually testing whether the focus analog gain voltage 495 is actually successful at this by applying it to a next frame. For example, the focus analog gain voltage 495 may be calculated by multiplying the imaging analog gain voltage by a ratio, wherein a numerator of the ratio includes a target luminance value that falls within the defined luminance range, wherein a denominator of the ratio includes the first average focus luminance. The focus analog gain voltage 495 may optionally be tested by amplifying (via analog gain circuitry 425) later-received signals (from a new frame) from the focus photodiodes to produce average focus pixel luminance 485 falling within the defined focus luminance range. For example, focus analog gain can be determined as equal to Previous Focus Gain*(Focus Luminance Target/Average Focus Pixel Luminance).

If the first average focus pixel luminance 485 is below the lower boundary of the defined focus luminance range, this is a low-light condition, and the focus analog gain voltage 495 should be set to correspond to an increase in amplification of the signals from the focus photodiodes, the increase in amplification relative to the default analog gain or previous focus gain proportional to the difference between the lower boundary of the defined focus luminance range and the average focus pixel luminance 485 (or alternately, the increase in amplification or increase in voltage pre-determined). A high settled exposure setting 492 sent to the focus gain control algorithm module 450 from the AGC and/or AE algorithm module 445 can also be evidence of a low-light condition suggesting that the average focus pixel luminance 485 should be compared to the lower boundary of the defined focus luminance range. If the average pixel focus luminance 485 is greater than the upper boundary of the defined focus luminance range, this is a high-light condition, and the focus analog gain voltage 495 should be set to correspond to a decrease in amplification of the data from the focus photodiodes, the decrease in amplification relative to the default analog gain or previous focus gain proportional to the difference between the average focus pixel luminance 485 and the upper boundary of the defined focus luminance range (or alternately, the decrease in amplification or decrease in voltage pre-determined). A low settled exposure setting 492 sent to the focus gain control algorithm module 450 from the AGC and/or AE algorithm module 445 can also be evidence of a high-light condition suggesting that the average focus pixel luminance 485 should be compared to the higher boundary of the defined focus luminance range.

Step 630 may be followed by steps 650, 655, and 660. Step 645 may be followed by steps 650, 655, and 660. At step 650, as discussed above, the one or more processors determine the focus analog gain (the second sensor gain) based on the first focus pixel data and/or based on the defined focus luminance range. For example, the focus analog gain (the second sensor gain) may be determined as in step 630 or as in step 645.

At step 655, the one or more processors send the imaging analog gain 490 (the first sensor gain) to be stored at the imaging gain register 415 of the image sensor 405, and the image sensor 405 applies the imaging analog gain 490 (the first sensor gain) to the imaging pixels (via the analog gain circuitry 425 and the imaging gain register 415) when capturing one or more subsequent frames. At step 660, the one or more processors send the focus analog gain 495 (the second sensor gain) to be stored at the focus gain register 420 of the image sensor 405, and the image sensor 405 applies the focus analog gain 495 (the second sensor gain) to the imaging pixels (via the analog gain circuitry 425 and the focus gain register 420) when capturing one or more subsequent frames. Steps 655 and 660 may be performed in parallel or sequentially in either order (i.e., with either step before the other).

In some cases, steps 655 and/or 660 of the operations 600 of FIG. 6 may be followed by, or may represent, step 705 of the operations 700 of FIG. 7. On the other hand, any of the steps of the operations 600 of FIG. 6, including step 605, may be preceded by all or at least a subset of the operations 800 of FIG. 8.

FIG. 7 is a flow diagram illustrating performance of phase detection auto focus based on the focus analog gain voltage. The performance of phase detection auto focus in the operations 700 of FIG. 7 are performed by one or more processors upon execution of stored instructions by the one or more processors. The phrase “one or more processors” in the context of FIG. 4 may, for example, refer to the image signal processor (ISP) 430, the application processor (AP) 440, both, another processor 1110 not shown in FIG. 4, or a combination thereof.

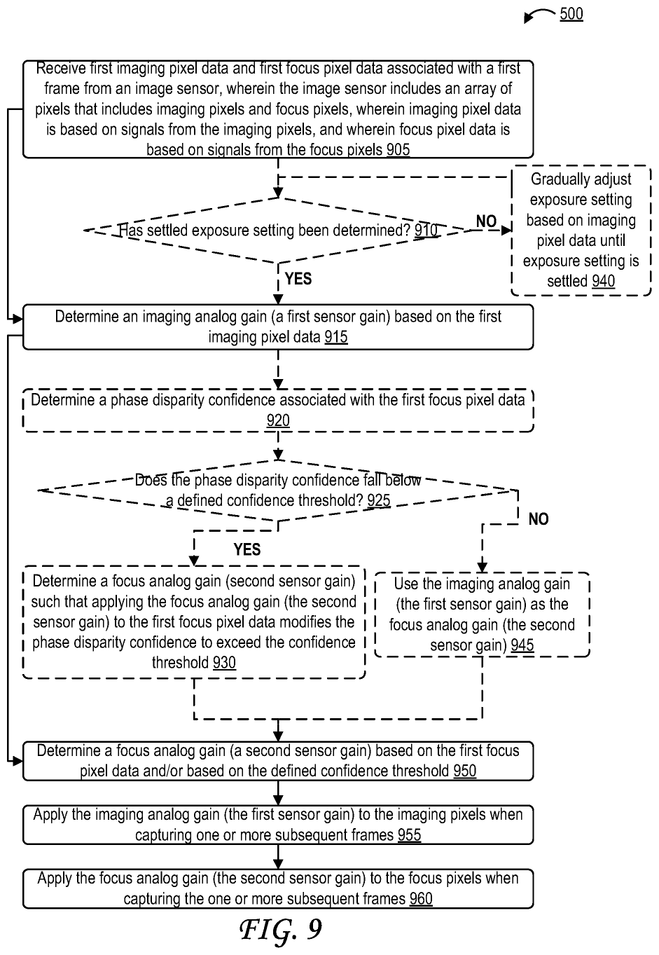

At step 705, the one or more processors receive later focus pixel data from the image sensor after receiving the focus pixel data from step 605 of FIG. 6 or from step 905 of FIG. 9; that is, from one or more later frames after the one or more first frames from step 605 or step 905. The one or more later frames may be or include the one or more subsequent frames of steps 655 and 660 of FIG. 6, may be or include the one or more subsequent frames of steps 955 and 960 of FIG. 9, and/or may be or include frames before or after the one or more subsequent frames. The later focus pixel data is based on later signals from the focus photodiodes that have been amplified at the image sensor 405 (by the analog gain circuitry 425) according to the focus analog gain voltage 495 that was determined at step 630 of FIG. 6 or at step 935 of FIG. 9. At step 710, the one or more processors determine one or more phase disparity values based on the later focus pixel data 475. That is, focus pixel data from a left focus pixel photodiode (that receives light only from a left side or angle) may be compared with focus pixel data from a right focus pixel photodiode (that receives light only from a right side or angle), and focus pixel data from a top focus pixel photodiode (that receives light only from a top side or angle) may be compared with focus pixel data from a bottom focus pixel photodiode (that receives light only from a bottom side or angle). The one or more phase disparity values determined at step 710 may include a phase disparity value for each pair of focus photodiodes, or may include an average of the phase disparity values calculated for each pair of focus photodiodes.

At step 715, the one or more processors determine whether the camera is out of focus based on the one or more phase disparity values. If the one or more phase disparity values at step 715 are non-zero, then the camera is out of focus, and step 715 is followed by step 720. At step 720, the one or more processors actuate one or more motors based on the phase disparity, wherein actuating the one or more motors causes a lens 110 of camera 400 to move from a first lens position to a second lens position, adjusting a focus of the camera 400. The direction of movement of the lens 110 may correspond to a direction in which the data from the focus photodiodes is determined to be out of phase, or whether the one or more phase disparity values are positive or negative. The distance of movement of the lens 110 may correspond to a degree or amount to which the data from the focus photodiodes are determined to be out of phase, or the absolute value of the phase disparity. In some cases, step 720 can also optionally include performance of contrast detection auto focus (CDAF) after the lens is moved to the second lens position by actuating the one or more motors to move to each of a plurality of lens positions within a predetermined distance of the second lens position, and by identifying a focused lens position that maximizes image contrast from the plurality of lens positions. This way, PDAF gets the focus of the camera very close to perfect, and CDAF further perfects the focus within a small range, which is less wasteful of energy and time than CDAF over the entire movement range of the lens.

If the one or more phase disparity values at step 715 are zero or very close to zero—that is, if there is no phase disparity—then the camera is in focus, and step 715 is followed by step 725. At step 725, the one or more processors identify that the camera is in focus based on the phase difference, and maintain the lens at the first lens position.

Step 720 can be followed by step 730. Step 725 can also be followed by step 730. Either way, step 730 commences after the camera 400 is in focus, either after the lens has finished moving at step 720 to the second lens position (or to a third position that the lens is moved to after the optional CDAF portion of step 720) or after the camera is determined at step 725 to be in focus. At step 730, the one or more processors receive later imaging pixel data 470 from the image sensor 405 after receiving the imaging pixel data 405 from step 605 of FIG. 6 or from step 905 of FIG. 9; that is, from one or more later frames after the one or more first frames from step 605 or step 905. The one or more later frames may be or include the one or more subsequent frames of steps 655 and 660 of FIG. 6, may be or include the one or more subsequent frames of steps 955 and 960 of FIG. 9, and/or may be or include frames before or after the one or more subsequent frames. In an alternate embodiment, step 730 may be merged with step 705 so that the later focus pixel data is received alongside the later imaging pixel data. The later focus pixel data is based on later signals from the imaging photodiodes that have been amplified at the image sensor by the imaging analog gain voltage 490. At step 735, the one or more processors generate an image based on the later imaging photodiode pixel data from the imaging photodiodes. The one or more later frames include the later imaging pixel data, wherein the later imaging pixel data includes later signals from the imaging photodiodes that have been amplified at the image sensor by the imaging analog gain voltage 490. More specifically, later imaging pixel data 470 is determined by de-mosaicing the later imaging pixel data 470 as discussed with respect to the de-mosaicing algorithm module 455 of FIG. 4, and can optionally be run through the pixel interpolation algorithm module 460 and/or the color space conversion algorithm module 458 and/or the image frame downsampling algorithm module 465, in any order, to produce the final focused image generated at step 735.

FIG. 8 is a flow diagram illustrating automatic exposure (AE) controls for determining a settled exposure setting and automatic gain control (AGC) for determining an imaging analog gain voltage for imaging pixel data. The performance of AE controls and AGC in the operations 800 of FIG. 8 are performed by one or more processors upon execution of stored instructions by the one or more processors. The phrase “one or more processors” in the context of FIG. 4 may, for example, refer to the image signal processor (ISP) 430, the application processor (AP) 440, both, another processor 1110 not shown in FIG. 4, or a combination thereof.

At step 805, the one or more processors receive previous imaging pixel data 470 from the image sensor 405 before receiving the imaging pixel data 470 from step 605 of FIG. 6 or from step 905 of FIG. 9. The previous imaging pixel data 470 is based on previous signals from the imaging photodiodes, which may for example be amplified by the analog gain circuitry 425 according to initial or default imaging analog gain voltage (or according to an intermediate imaging analog gain voltage when step 805 is returned to after step 820 or after step 825). At step 808, the one or more processors determine the average imaging pixel luminance 480 based on the previous imaging pixel data 470. At step 810, the one or more processors determine whether the average imaging pixel luminance 480 falls outside of a defined imaging luminance range. The lower and upper boundaries of the defined imaging luminance range may represent average luminance values that generally produce visually pleasing images based on characteristics of the image sensor 405 such as noise, saturation and/or color response. If the average imaging pixel luminance 480 falls outside of a defined imaging luminance range, then step 810 is followed by step 815; otherwise, step 810 is followed by step 830. At step 815, the one or more processors determine whether the first average imaging luminance falls outside of the defined imaging luminance range by more than a threshold amount N₄, where N₄ is for example 1, 2, 3, 4, 5, 6, 7, 8, 9, 10, 11, 12, 13, 14, or 15. If the average imaging pixel luminance 480 falls outside of a defined imaging luminance range by more than the threshold amount N₄, then step 815 is followed by step 820; otherwise, step 815 is followed by step 825.

At step 820, the one or more processors make a gradual adjustment to the exposure setting, the gradual adjustment aimed at moving the average imaging pixel luminance 480 toward the defined imaging luminance range at the next frame. If the average imaging pixel luminance 480 is below the lower boundary of the defined imaging luminance range by more than the threshold amount, this is a low-light condition, and the gradual adjustment to the exposure setting can be an increase in exposure time, for example by a predetermined time interval, optionally combined with an increase in imaging analog gain as discussed further with respect to step 825. If the average imaging pixel luminance 480 is greater than the upper boundary of the defined imaging luminance range by more than the threshold amount, this is a high-light condition, and the gradual adjustment to the exposure setting can be a decrease in exposure time, for example by a predetermined time interval, optionally combined with a decrease in imaging analog gain as discussed further with respect to step 825. Step 825 is followed by step 805 because the updated exposure setting is sent to the exposure control 418, and the image sensor 405 applies it in one of the next imaging frames (there may be one or more skipped frames in between as discussed with respect to FIG. 10A), from which imaging pixel data 470 is reviewed as discussed above with respect to steps 805 through 815. The average imaging pixel luminance 480 for the next reviewed imaging frame should be closer to the nearest boundary of the defined imaging luminance range. The gradual adjustments to exposure of step 820 thus result in a loop back to step 805 until the exposure is eventually settled at step 825 or step 830; that is, the exposure time is no longer changing and has converged over time to a static, or constant, value. Step 820 of the operations 800 can correspond to step 640 of the operations 600 and/or step 940 of the operations 900.

At step 825, the one or more processors identify that the exposure setting is settled, since the average imaging pixel luminance 480 is within the threshold amount of the nearest boundary of the defined imaging luminance range. At step 825, the one or more processors also determine an imaging analog gain voltage 490 aimed at moving the average imaging pixel luminance 480 toward or within the defined imaging luminance range. If the average imaging pixel luminance 480 is below the lower boundary of the defined imaging luminance range by less than the threshold amount, this is a relatively low-light condition, and the imaging analog gain voltage 490 should be set to correspond to an increase in amplification of the data from the imaging photodiodes, the increase in amplification relative to the default analog gain voltage proportional to the difference between the lower boundary of the defined imaging luminance range and the average imaging pixel luminance 480 (or alternately, the increase in amplification or increase in voltage pre-determined). If the average imaging pixel luminance 480 is greater than the upper boundary of the defined imaging luminance range by less than the threshold amount, this is a relatively high-light condition, and the imaging analog gain voltage 490 should be set to correspond to a decrease in amplification of the data from the imaging photodiodes, the decrease in amplification relative to the default analog gain voltage proportional to the difference between the average imaging pixel luminance 480 and the upper boundary of the defined imaging luminance range (or alternately, the decrease in amplification or decrease in voltage pre-determined). Step 825 of the operations 800 can correspond to step 615 of the operations 600 or step 915 of the operations 900. Step 825 can be the end of the operations 800, or be followed either by step 830 or by step 805, with step 805 optionally chosen to test the effect of the imaging analog gain voltage 490 and confirm that amplifying later imaging photodiode signals via the imaging analog gain voltage 490 results in an average imaging pixel luminance 480 that is within the defined imaging luminance range. In some cases, step 825 can alternately or additionally be based on gain settings that reduce noise (e.g., gain is only increased the minimum amount needed to reach or exceed the lower boundary of the imaging luminance range to avoid unnecessary increases in image noise). In some cases, instead of an imaging luminance range, there is only a threshold corresponding to a minimum (similar to the lower bound of a range with no upper bound) or to a maximum (similar to the upper bound of a range with no lower bound).

At step 830, the one or more processors identify that the exposure setting is settled and that the imaging analog gain voltage 490 is determined, since the average imaging pixel luminance 480 is within the defined imaging luminance range. Step 825 of the operations 800 can also correspond to step 615 of the operations 600.

In some cases, step 825 of the operations 800 of FIG. 8 may be followed either by step 605 of the operations 600 of FIG. 6 or by step 905 of the operations 900 of FIG. 9. Similarly, step 830 of the operations 800 of FIG. 8 may be followed either by step 605 of the operations 600 of FIG. 6 or by step 905 of the operations 900 of FIG. 9. Step 825 or step 830 of the operations 800 of FIG. 8 may also eventually be followed by step 705 of the operations 700 of FIG. 7.

FIG. 9 is a flow diagram illustrating processing of image sensor data to determine an imaging analog gain voltage for imaging pixel data and a focus analog gain voltage for focus pixel data based on confidence. The operations 900 of FIG. 9 represent a specific implementation of the operations 500 of FIG. 5. The performance of phase detection auto focus in the operations 700 of FIG. 7 are performed by one or more processors upon execution of stored instructions by the one or more processors. The phrase “one or more processors” in the context of FIG. 4 may, for example, refer to the image signal processor (ISP) 430, the application processor (AP) 440, both, another processor 1110 not shown in FIG. 4, or a combination thereof.

The process 900 of FIG. 9 is similar to the process 600 of FIG. 6, but is based on confidence rather than luminance. Step 905 is identical to step 605; step 910 is identical to step 610; step 915 is identical to step 615; step 940 is identical to step 640; step 945 is identical to step 645; step 955 is identical to step 655; and step 960 is identical to step 660. Descriptions of steps 605, 610, 615, 640, 645, 655, and 660 of FIG. 6 therefore serve also as descriptions of steps 905, 910, 915, 940, 945, 955, and 960 of FIG. 9, respectively.

At step 920, the one or more processors optionally determine one or more phase disparity confidence values associated with the focus pixel data 475, optionally also determining one or more phase disparity values associated with the focus pixel data 475. In some cases, the one or more phase disparity values corresponding to the one or more phase disparity confidence values may be individual phase disparity values for each corresponding pair of focus photodiodes (left and right, top and bottom, and so forth), or may be an average of multiple such phase disparity values for multiple pairs of focus photodiodes from the pixel array 410 of the image sensor 405.

In some cases, the phase disparity confidence may be calculated by calculating a Sum of Absolute Difference (SAD) of all paired focus pixel data (e.g., right and left focus photodiodes, top and down focus photodiodes), according to the following equation:

$$SAD = {\sum }_{k = 0}^{n} Abs ( Left ( k ) - Right ( k ) )$$

The SAD is then translated to a confidence value using a lookup table. The lookup table's correlations between SAD and confidence value may be based on characteristics of the image sensor 405 such as noise, saturation and color response. In short, the confidence value is proportional to the sum (or in alternate cases an average) of phase disparity values.

At optional step 925, the one or more processors identify whether the confidence value falls below a threshold confidence value. If the confidence value falls below the threshold confidence value, then step 925 is followed by step 930; otherwise, step 925 is followed by step 945. The threshold confidence value may be, for example, 40% confidence, 50% confidence, 60% confidence, 70% confidence, 80% confidence, 90% confidence, 95% confidence, or 100% confidence. At step 930, the one or more processors determine a focus analog gain voltage 495 such that applying the focus analog gain (the second sensor gain) to the first focus pixel data modifies the phase disparity confidence to exceed the confidence threshold. That is, a second phase disparity confidence value, which is associated with one or more phase disparity values associated with signals from the focus photodiodes amplified by the focus analog gain voltage 495, exceeds the threshold confidence value. The focus analog gain voltage 495 is therefore calculated so as to push the second phase disparity confidence value up towards, to, or to exceed, the threshold confidence value. The focus analog gain voltage 495 is may optionally be calculated to bring the second phase disparity confidence value up to or past the threshold confidence value hypothetically without actually testing whether the focus analog gain voltage 495 is actually successful at this by applying it to a next frame. For example, the focus analog gain voltage 495 may be calculated to be equal to Previous Focus Gain*(Confidence Threshold/Phase Disparity Confidence), where previous focus gain may be set to imaging gain or another default gain, or may be set to an intermediate focus gain value if the focus gain is gradually adjusted over multiple adjustment cycles). Alternately, the determined focus analog gain voltage 495 may be tested by amplifying later signals from the focus photodiodes at a next frame to ensure that a second phase disparity confidence value calculated based on the resulting focus pixel data reaches or exceeds the threshold confidence value.

Step 930 may be followed by steps 950, 955, and 960. Step 945 may be followed by steps 950, 955, and 960. At step 950, as discussed above, the one or more processors determine the focus analog gain (the second sensor gain) based on the first focus pixel data and/or based on the defined confidence threshold. For example, the focus analog gain (the second sensor gain) may be determined as in step 930 or as in step 945.

At step 955, the one or more processors send the imaging analog gain 490 (the first sensor gain) to be stored at the imaging gain register 415 of the image sensor 405, and the image sensor 405 applies the imaging analog gain 490 (the first sensor gain) to the imaging pixels (via the analog gain circuitry 425 and the imaging gain register 415) when capturing one or more subsequent frames. At step 660, the one or more processors send the focus analog gain 495 (the second sensor gain) to be stored at the focus gain register 420 of the image sensor 405, and the image sensor 405 applies the focus analog gain 495 (the second sensor gain) to the imaging pixels (via the analog gain circuitry 425 and the focus gain register 420) when capturing one or more subsequent frames. Steps 655 and 660 may be performed in parallel or sequentially in either order (i.e., with either step before the other).

In some cases, step 935 of the operations 900 of FIG. 9 may be followed by step 705 of the operations 700 of FIG. 7. Similarly, step 945 of the operations 900 of FIG. 9 may be followed by step 705 of the operations 700 of FIG. 7. On the other hand, any of the steps of the operations 900 of FIG. 9, including step 905, may be preceded by all or at least a subset of the operations 800 of FIG. 8.

FIG. 10A illustrates frame skipping in the context of a frame capture timeline. That is, in FIG. 10A, a frame is skipped between determining updated analog gain and exposure settings and application of the new analog gain and exposure settings. In particular, a timeline 1000 spanning 80 milliseconds (ms) of time is illustrated as including three frames: a first frame 1005 spanning 20 ms of exposure with analog gain set to 1V, a second frame 1010 spanning 20 ms of exposure with analog gain set to 1V, and a third frame 1015 spanning 40 ms of exposure with analog gain set to 1.8V. A new analog exposure setting (40 ms) and analog gain voltage (1.8V) are determined during or based on the first frame 1005 as indicated by box 1020, but because new exposure settings and analog gain voltages can take time for the camera to apply, these new exposure settings and analog gain voltages only take effect at the third frame 1015. Thus, in discussions herein referencing updated analog gain voltages and/or exposure settings being applied to a “next” frame, the “next” frame may be a next frame sequentially, or may be a next frame at which the updated analog gain voltages and/or exposure settings are able to be applied. This, there may be one or more skipped frames in between the frame at which the updated analog gain voltages and/or exposure settings are determined and the frame at which the updated analog gain voltages and/or exposure settings are applied.

FIG. 10B illustrates exposure adjustment in the context of a frame capture timeline. That is, in FIG. 10B, exposure can be lengthened exclusively for focus photodiodes or imaging photodiodes. In particular, three frames captured during a span of 90 milliseconds (ms) of time illustrated as a timeline 1050. The first frame 1055 is captured with an exposure time of 20 ms. The second frame 1060 is captured with an exposure time of 30 ms. The third frame 1065 is captured with an exposure time of 40 ms. A first label 1070 indicates that the second and third frames are treated together as one single frame by photodiodes of type A, while labels 1080 and 1085 indicate that the second and third frames are treated separately as separate frames by photodiodes of type B.

In one case, photodiodes of type A may refer to focus photodiodes while photodiodes of type B may refer to focus photodiodes. In this case, the focus photodiodes have a lengthened 70 ms exposure time. Such a function may be useful in extreme low-light conditions where exposure of focus frames may be lengthened to improve PDAF focus. In another case, photodiodes of type A may refer to imaging photodiodes while photodiodes of type B may refer to focus photodiodes. In this case, the imaging photodiodes have a lengthened 70 ms exposure time, while the focus photodiodes have two frames, one with 30 ms exposure time and one with 40 ms exposure time. Such a function may be useful in extreme high-light conditions where exposure of focus frames may be limited to improve PDAF focus.

Some benefits of using PDAF with separated analog gain controls as described herein—that is, PDAF where different voltages of analog gain are applied to amplify data from imaging photodiodes than to amplify data from focus photodiodes—include resolution of existing PDAF limitations, such as poor performance in low light and high light, and poor performance in low confidence situations such as low contrast or low signal-to-noise (SNR) conditions. Use of separated analog gain controls a camera's improved focus using PDAF in low-light or high-light conditions, as well as when photographing subjects without prominent features that might otherwise be susceptible to noise interfering with focus.

FIG. 11 shows an example of computing system 1100, which can be for example any computing device making up internal computing system 110, remote computing system 100, a camera 100A, camera 100B, camera 100C, camera 200A, camera 200B, camera 200C, camera 300, apparatus 800, apparatus 1000, or any component thereof in which the components of the system are in communication with each other using connection 1105. Connection 1105 can be a physical connection via a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache of high-speed memory 1112 connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

In the foregoing description, aspects of the application are described with reference to specific embodiments thereof, but those skilled in the art will recognize that the subject matter of this application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Claim language or other language reciting “at least one or a set or tone or more or a set” indicates that one member of the set or multiple members of die set satisfy the claim. For example, claim language reciting “at least one of A and B” means A, B, or A and B. In another example, claim language reciting “one or more of A and B” means A, B, or A and B. In another example, claim language reciting “one or more of A. B, and C” means A, B, C, A and B, A and C, B and C, or all of A, B, and C.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules.

What is claimed is:

1. A method comprising:
receiving first imaging pixel data and first focus pixel data associated with a first frame from an image sensor, wherein the image sensor includes an array of pixels that includes imaging pixels and focus pixels, wherein imaging pixel data is based on signals from the imaging pixels, and wherein focus pixel data is based on signals from the focus pixels;
determining a first sensor gain based on the first imaging pixel data;
determining a second sensor gain based on the first focus pixel data;
applying the first sensor gain to the imaging pixels when capturing one or more subsequent frames; and
applying the second sensor gain to the focus pixels when capturing the one or more subsequent frames.

2. The method of claim 1, further comprising:
storing the first sensor gain in a first register of the image sensor; and
storing the second sensor gain in a second register of the image sensor.

3. The method of claim 1, wherein the image sensor includes a programmable gain amplifier (PGA), wherein applying the first sensor gain to the imaging pixels is performed using the PGA, wherein applying the second sensor gain to the focus pixels is performed using the PGA.

4. The method of claim 1, further comprising:
determining an average focus pixel luminance associated with the first focus pixel data;
identifying that the average focus pixel luminance falls outside of a luminance range; and
determining the second sensor gain based on the luminance range.

5. The method of claim 4, wherein the second sensor gain is determined based on the luminance range such that applying the second sensor gain to the first focus pixel data modifies the average focus pixel luminance to fall within the defined luminance range.

6. The method of claim 4, wherein the first sensor gain and the second sensor gain are different.

7. The method of claim 1, further comprising:
determining an average focus pixel luminance associated with the first focus pixel data;
identifying that the average focus pixel luminance falls within a luminance range; and
determining the second sensor gain based on the first sensor gain.

8. The method of claim 7, wherein the first sensor gain and the second sensor gain are equivalent.

9. The method of claim 1, further comprising:
determining a phase disparity confidence associated with the first focus pixel data;
identifying that the phase disparity confidence falls below a confidence threshold; and
determining the second sensor gain based on the confidence threshold.

10. The method of claim 9, wherein the second sensor gain is determined based on the confidence threshold such that applying the second sensor gain to the first focus pixel data modifies the phase disparity confidence to exceed the confidence threshold.

11. A system comprising:
an image sensor that includes an array of pixels, the array of pixels including imaging pixels and focus pixels;
one or more memory devices storing instructions; and
one or more processors executing the instructions, wherein execution of the instructions by the one or more processors causes the one or more processors to:
receive first imaging pixel data and first focus pixel data associated with a first frame from an image sensor, wherein imaging pixel data is based on signals from the imaging pixels, and wherein focus pixel data is based on signals from the focus pixels,
determine a first sensor gain based on the first imaging pixel data,
determine a second sensor gain based on the first focus pixel data,
send the first sensor gain to the image sensor, causing the image sensor to apply the first sensor gain to the imaging pixels when capturing one or more subsequent frames, and
send the second sensor gain to the image sensor, causing the image sensor to apply the second sensor gain to the focus pixels when capturing the one or more subsequent frames.

12. The system of claim 11, wherein the image sensor includes a first register and a second register, wherein sending the first sensor gain to the image sensor causes the image sensor to store the first sensor gain in the first register, wherein sending the second sensor gain to the image sensor causes the image sensor to store the second sensor gain in the second register.

13. The system of claim 11, wherein the image sensor includes a programmable gain amplifier (PGA), wherein the image sensor applies the first sensor gain to the imaging pixels using the PGA, wherein the image sensor applies the second sensor gain to the focus pixels using the PGA.

14. The system of claim 11, wherein execution of the instructions by the one or more processors causes the one or more processors to further:
determine an average focus pixel luminance associated with the first focus pixel data,
identify that the average focus pixel luminance falls outside of a luminance range, and
determine the second sensor gain based on the luminance range.

15. The system of claim 14, wherein the second sensor gain is determined based on the luminance range such that applying the second sensor gain to the first focus pixel data modifies the average focus pixel luminance to fall within the defined luminance range.

16. The system of claim 14, wherein the first sensor gain and the second sensor gain are different.

17. The system of claim 11, wherein execution of the instructions by the one or more processors causes the one or more processors to further:
determine an average focus pixel luminance associated with the first focus pixel data,
identify that the average focus pixel luminance falls within a luminance range, and
determine the second sensor gain based on the first sensor gain.

18. The system of claim 17, wherein the first sensor gain and the second sensor gain are equivalent.

19. The system of claim 11, wherein execution of the instructions by the one or more processors causes the one or more processors to further:
determine a phase disparity confidence associated with the first focus pixel data,
identify that the phase disparity confidence falls below a confidence threshold, and
determine the second sensor gain based on the confidence threshold.

20. The system of claim 19, wherein the second sensor gain is determined based on the confidence threshold such that applying the second sensor gain to the first focus pixel data modifies the phase disparity confidence to exceed the confidence threshold.

21. A non-transitory computer readable storage medium having embodied thereon a program, wherein the program is executable by one or more processors to perform a method, the method comprising:
receiving first imaging pixel data and first focus pixel data associated with a first frame from an image sensor, wherein the image sensor includes an array of pixels that includes imaging pixels and focus pixels, wherein imaging pixel data is based on signals from the imaging pixels, and wherein focus pixel data is based on signals from the focus pixels;
determining a first sensor gain based on the first imaging pixel data;
determining a second sensor gain based on the first focus pixel data;
applying the first sensor gain to the imaging pixels when capturing one or more subsequent frames; and
applying the second sensor gain to the focus pixels when capturing the one or more subsequent frames.

22. The non-transitory computer readable storage medium of claim 21, the method further comprising:
storing the first sensor gain in a first register of the image sensor; and
storing the second sensor gain in a second register of the image sensor.

23. The non-transitory computer readable storage medium of claim 21, wherein the image sensor includes a programmable gain amplifier (PGA), wherein applying the first sensor gain to the imaging pixels is performed using the PGA, wherein applying the second sensor gain to the focus pixels is performed using the PGA.

24. The non-transitory computer readable storage medium of claim 21, the method further comprising:
determining an average focus pixel luminance associated with the first focus pixel data;
identifying that the average focus pixel luminance falls outside of a luminance range; and
determining the second sensor gain based on the luminance range.

25. The non-transitory computer readable storage medium of claim 24, wherein the second sensor gain is determined based on the luminance range such that applying the second sensor gain to the first focus pixel data modifies the average focus pixel luminance to fall within the defined luminance range.

26. The non-transitory computer readable storage medium of claim 24, wherein the first sensor gain and the second sensor gain are different.

27. The non-transitory computer readable storage medium of claim 21, further comprising:
determining an average focus pixel luminance associated with the first focus pixel data;
identifying that the average focus pixel luminance falls within a luminance range; and
determining the second sensor gain based on the first sensor gain.

28. The non-transitory computer readable storage medium of claim 27, wherein the first sensor gain and the second sensor gain are equivalent.

29. The non-transitory computer readable storage medium of claim 21, further comprising:
determining a phase disparity confidence associated with the first focus pixel data;
identifying that the phase disparity confidence falls below a confidence threshold; and
determining the second sensor gain based on the confidence threshold.

30. A method comprising:
receiving imaging pixel data and focus pixel data from an image sensor, wherein the image sensor includes an array of pixels that includes imaging pixels and focus pixels, wherein the imaging pixel data is based on signals from the imaging pixels, and wherein focus pixel data is based on signals from the focus pixels;
applying a first sensor gain to the imaging pixels; and
applying a second sensor gain that is different from the first sensor gain to the focus pixels.
